(19) United States
(12) Patent Application Publication
(10) Pub. No.: US 2026/0321076 A1
(43) Pub. Date: Oct. 15, 2026

(54) PHYSICAL ACCESS CONTROL VIA USER PERMISSION LEVELS

(71) Applicant: Uson L.P., Houston, TX (US)

(72) Inventors: Olivia Nellie Pacheco, Houston, TX (US); Royce Allen Simpson, Kokomo, IN (US)

(21) Appl. No.: 19/468,877

(22) Filed: Feb. 3, 2026

Related U.S. Application Data
(60) Provisional application No. 63/753,327, filed on Feb. 3, 2025.

(51) Int. Cl. G07C 9/00

(52) U.S. Cl. CPC G07C 9/00174

(57) ABSTRACT

Leak testing systems, methods, and non-transitory computer readable media are disclosed that in some examples include a channel box and an enclosure configured to receive the channel box, coupled to a display device via electronic latches, and housing memory having instructions stored thereon and a main control unit (MCU) coupled to the memory and the electronic latches and configured to execute the stored instructions. In some examples, the MCU is configured to determine that a user is authorized to access the channel box in response to an access request received from the user after authenticating credentials for the user received with a login request via a user interface output to the display device. The MCU then control the electronic latches to disengage to thereby unlock the display device. The MCU can further determine that the enclosure was closed and control the electronic latches to re-engage to lock the display device.

### CROSS-REFERENCE TO RELATED APPLICATIONS

This application claims the benefit of priority of U.S. Provisional Patent Application Ser. No. 63/753,327, filed on Feb. 3, 2025, entitled “Physical Access Control via User Permission Levels,” the entire contents of which is hereby incorporated by reference herein.

### FIELD

This technology generally relates to systems and methods for air leak testing and, more particularly, to securing physical access control to leak testing systems via user permission levels.

### BACKGROUND

Leak testing systems help to ensure the integrity and reliability of sealed components and assemblies across various industries. These systems rely on control of electronic parameters and physical settings, such as regulators, flow controllers, and pneumatic pressure levels, to achieve consistent and repeatable test results.

Traditionally, access to critical system components, including test program configurations, pneumatic regulators, and sensor calibration settings, has been unrestricted or limited to rudimentary physical tamper-prevention measures. In many existing leak testing systems, these controls are accessible from outside the test enclosure, creating security vulnerabilities that can lead to accidental misconfiguration, unauthorized modifications, or tampering. Such risks compromise the accuracy and reliability of test results and may introduce compliance concerns in regulated industries.

Industries operating under regulatory frameworks, such as FDA and ISO 13485, impose strict requirements on change traceability, system security, and auditability of testing equipment. Specifically, any modification to system settings, including changes to leak test parameters, regulator adjustments, or sensor recalibration, must be logged and associated with an authenticated user to ensure accountability. Conventional leak testing systems lack robust mechanisms for enforcing role-based access control, maintaining automated audit trails, and restricting physical access to critical components.

### SUMMARY

Provided herein are systems and methods for controlled physical access to modular leak testing systems, wherein access to components is restricted based on user permission levels. In some examples, the leak testing system integrates software-controlled electronic latching mechanisms to prevent unauthorized access to internal components within the primary enclosure. In some examples, a graphical user interface authentication system governs access to these components by requiring user identification credentials prior to permitting access.

In some examples, a fail-secure electronic latch system may be implemented to maintain the enclosure in a locked state during power failures. A secondary mechanical override mechanism may be provided for emergency access, with each override event logged to maintain an auditable record. In some embodiments, the leak testing system incorporates real-time access monitoring via sensors integrated within the electronic latches, wherein leak testing system operation may be automatically restricted when the enclosure is open.

In some examples, the access control system operates by receiving an access request via a use interface (UI), wherein the request is evaluated against predefined role-based permission levels. If the request is approved and the leak testing system is in an operationally safe state, the electronic latching system disengages to allow physical access. In some examples, all access attempts, whether successful or denied, are automatically recorded in a secure audit log, including user credentials, timestamps, and details of any modifications performed.

In some examples, the leak testing system may be configured to integrate with a remote monitoring server, allowing administrative personnel to review audit logs and access alerts in real time. Unauthorized access attempts may trigger configurable security notifications, providing alerts to designated personnel or systems.

In some examples, the access control system supports multiple permission levels, allowing differentiation between roles such as, but not limited to operator, technician, and administrator. Access restrictions may be dynamically configured via user management settings, ensuring compliance with FDA, ISO13485, or other regulatory requirements. In other examples, the leak testing system may implement safety interlocks that prevent test execution while the enclosure is open. Embedded sensors may detect the open or closed state of the enclosure, and test operations remain disabled until the electronic latches are securely engaged.

In some examples, a leak testing system is disclosed that includes at least one channel box and an enclosure configured to receive the channel box, coupled to a display device via one or more electronic latches, and housing memory having instructions stored thereon and a main control unit (MCU) coupled to the memory and the electronic latches and configured to execute the stored instructions. The MCU is configured to determine that a user is authorized to access the channel box in response to an access request received from the user after authenticating credentials for the user received with a login request via a user interface output to the display device. The MCU can then control the electronic latches to disengage to thereby unlock the display device and permit movement of the display device away from the enclosure. User access to the channel box is permitted when the display device is unlocked. The MCU can also determine that the enclosure was closed and control the electronic latches to re-engage to thereby lock the display device and restrict movement of the display device relative to the enclosure. User access to the channel box is prevented when the display device is locked.

In these examples, the channel box can comprises a plurality of components and the MCU can further be configured to execute the stored instructions to monitor one or more interactions with one or more of the components and log audit data associated with the interactions. The audit data can comprise one or more of a time the interactions occurred, the one or more of the components associated with the interactions, or one or more parameters of the one or more of the components that were adjusted as part of the interactions. The channel box in these examples can comprise one or more sensors, one or more test ports, one or more pressure regulators, or valving and the components comprise at least one main regulator, at least one auxiliary manual regulator, and an internal vacuum generation circuit.

Additionally, the channel box can comprises a test channel controller (TCC), the MCU can be communicably coupled to the TCC when the channel box is received by the enclosure, and the MCU can further be configured to execute the stored instructions to monitor the interactions with the components based on one or more communications with the TCC. The TCC can comprise a TCC printed circuit board (PCB) comprising a first set of one or more processors, the MCU can comprise a second set of one or more processors, and the enclosure can further comprise a backplane printed circuit board (PCB) configured to connect the MCU to the TCC PCB via a backplane interface connector of the TCC PCB.

The MCU in some examples is further configured to execute the stored instructions to determine that the enclosure was closed based on position data received from one or more sensors coupled to the enclosure proximate the electronic latches. The position data indicates proximity of the display device relative to the enclosure. The MCU can further be configured to execute the stored instructions to log audit data associated with one or more of the access request or the closure of the enclosure. The audit data can comprise at least an identity of the user and a timestamp of the access request or the closure of the enclosure. The MCU can further be configured to execute the stored instructions to provide via one or more communications networks at least a portion of the audit data in response to a request received from a remote monitoring server coupled to the leak testing system via the communications networks.

The MCU can also be configured to execute the stored instructions to determine that the user is unauthorized to access the channel box in response to the access request when a test procedure is currently executing on the leak testing system. The leak testing system in some examples can further include a control panel coupled to the MCU and the electronic latches and housing latch control circuitry. The MCU can be configured to control the electronic latches to disengage and re-engage via communication with the latch control circuitry in these examples.

The MCU can further be configured to execute the stored instructions to generate and output an alert upon determining that the user is unauthorized to access the channel box. The electronic latches can also be configured to remain engaged during a power failure such that user access to the channel box is prevented. Additionally, the enclosure can be coupled to the display device via a screen latch override comprising a mechanical latch operable via a key and the MCU can be further configured to execute the stored instructions to log audit data associated with a mechanical access upon determining that the enclosure was mechanically accessed via the screen latch override. Further, the leak testing system can include a plurality of other channel boxes, each separately removable from the enclosure.

In another example, a non-transitory computer readable medium is disclosed that has stored thereon instructions comprising executable code that, when executed by one or more processors of a main control unit (MCU) of a leak testing system, causes the one or more processors to carry out a method. The method can include determining that a user is authorized to access a channel box in response to an access request received from the user after authenticating credentials for the user received with a login request via a user interface output to a display device coupled to an enclosure of the leak testing system via one or more electronic latches. The enclosure can be configured to receive the channel box and the MCU can be coupled to the electronic latches. The method further includes controlling the electronic latches to disengage to thereby unlock the display device and permit movement of the display device away from the enclosure. User access to the channel box is permitted when the display device is unlocked. The method also includes determining that the enclosure was closed and controlling the electronic latches to re-engage to thereby lock the display device and restrict movement of the display device relative to the enclosure. User access to the channel box is prevented when the display device is locked.

In these examples, the channel box can comprise a plurality of components and the executable code, when executed by the processors, can further cause the processors to monitor one or more interactions with one or more of the components and log audit data associated with the interactions. The executable code, when executed by the processors, can further cause the processors to log audit data associated with one or more of the access request or the closure of the enclosure. The audit data can comprise at least an identity of the user and a timestamp of the access request or the closure of the enclosure.

In some examples, the enclosure is further coupled to the display device via a screen latch override comprising a mechanical latch operable via a key. In these examples, the executable code, when executed by the processors, can further cause the processors to log audit data associated with a mechanical access upon determining that the enclosure was mechanically accessed via the screen latch override.

In yet other examples, a method implemented by a main control unit (MCU) of a leak testing system is disclosed. The method in these examples includes determining that a user is authorized to access a channel box in response to an access request received from the user after authenticating credentials for the user received with a login request via a user interface output to a display device coupled to an enclosure of the leak testing system via one or more electronic latches. The enclosure can be configured to receive the channel box and the MCU is coupled to the electronic latches. The electronic latches can be controlled to disengage to thereby unlock the display device and permit movement of the display device away from the enclosure, wherein user access to the channel box is permitted when the display device is unlocked. A determination is then made that the enclosure was closed and the electronic latches are controlled to re-engage to thereby lock the display device and restrict movement of the display device relative to the enclosure. User access to the channel box is prevented when the display device is locked.

### BRIEF DESCRIPTION OF THE FIGURES

The accompanying drawings, which are incorporated in and form a part of the specification, illustrate exemplary embodiments and together with the written description serve to explain the principles, characteristics, and features of the technology. In the drawings:

FIG. 1 is a block diagram of exemplary leak testing system components, in accordance with at least one aspect of the present disclosure;

FIGS. 2A-D illustrate open and closed configurations of an exemplary leak testing system, in accordance with at least one aspect of the present disclosure;

FIG. 3 illustrates an exemplary leak testing system architecture, in accordance with at least one aspect of the present disclosure;

FIG. 4 is a front view of an exemplary leak testing system in an open configuration, in accordance with at least one aspect of the present disclosure;

FIGS. 5A-B illustrate an exemplary leak testing system benchtop configuration and wall-mounted configurations, in accordance with at least one aspect of the present disclosure;

FIG. 6 is a rear view of an exemplary leak testing system, in accordance with at least one aspect of the present disclosure;

FIG. 7 illustrates an exemplary leak testing system screen latch override, in accordance with at least one aspect of the present disclosure;

FIG. 8A-C illustrates an exemplary sequence of operations required to dock, undock, and remove a leak testing system channel box, in accordance with at least one aspect of the present disclosure;

FIGS. 9A-C illustrates exemplary leak testing system user interfaces, in accordance with at least one aspect of the present disclosure;

FIG. 10 illustrates an exemplary leak testing system enclosure, in accordance with at least one aspect of the present disclosure;

FIG. 11 illustrates an exemplary the leak testing system access mechanism, in accordance with at least one aspect of the present disclosure;

FIG. 12 illustrates an exemplary leak testing system with a channel box removed, in accordance with at least one aspect of the present disclosure;

FIGS. 13A-B illustrate an exemplary leak testing system channel box extracted from a leak testing system enclosure, in accordance with at least one aspect of the present disclosure;

FIG. 14 is an exemplary leak testing system backplane printed circuit board, in accordance with at least one aspect of the present disclosure;

FIG. 15 illustrates an exemplary leak testing system engagement mechanism between a distribution manifold and a receiving manifold, in accordance with at least one aspect of the present disclosure;

FIG. 16 illustrates an exemplary leak testing system receiving manifold engagement mechanism, in accordance with at least one aspect of the present disclosure;

FIG. 17 illustrates exemplary external device types supported by an exemplary leak testing system, in accordance with at least one aspect of the present disclosure;

FIG. 18 illustrates an exemplary leak testing system operation in asynchronous mode, in accordance with at least one aspect of the present disclosure;

FIG. 19 illustrates an exemplary leak testing system operation in sequenced mode, in accordance with at least one aspect of the present disclosure; and

FIG. 20 is a flowchart of an exemplary method for securing physical access control to leak testing systems via user permission levels, in accordance with at least one aspect of the present disclosure.

### DETAILED DESCRIPTION

This disclosure is not limited to the particular systems, devices, and methods described, as these may vary. The terminology used in the description is for the purpose of describing exemplary versions or embodiments only and is not intended to limit the scope.

The terms “algorithm,” “system,” “module,” “engine,” or “architecture,” if used herein, are not intended to be limiting of any particular implementation for accomplishing and/or performing the actions, steps, processes, etc., attributable to and/or performed thereby. An algorithm, system, module, engine, and/or architecture may be, but is not limited to, software, hardware and/or firmware or any combination thereof that performs the specified functions including, but not limited to, any use of a general and/or specialized processor in combination with appropriate software loaded or stored in a machine-readable memory and executed by the processor.

Further, any name associated with a particular algorithm, system, module, and/or engine is, unless otherwise specified, for purposes of convenience of reference and not intended to be limiting to a specific implementation. Additionally, any functionality attributed to an algorithm, system, module, engine, and/or architecture may be equally performed by multiple algorithms, systems, modules, engines, and/or architectures incorporated into and/or combined with the functionality of another algorithm, system, module, engine, and/or architecture of the same or different type, or distributed across one or more algorithms, systems, modules, engines, and/or architectures of various configurations.

Disclosed herein are systems and methods for controlling physical access to components within a modular leak testing system 100. In some examples, the leak testing system integrates permission-based electronic latching mechanisms to restrict unauthorized access to adjustable or serviceable components housed within the primary enclosure 102. Access to these components may be governed by a combination of hardware and software controls, ensuring that only authorized users, as defined by user permission levels, can gain entry. In some examples, the leak testing system 100 incorporates automated logging functionality, which records all access attempts and component interactions, thereby enhancing compliance with audit and regulatory requirements.

The leak testing system may operate in conjunction with a user interface (UI) that manages access requests. Users requesting physical access to the enclosure 102 may authenticate through the UI, which can evaluate their permission level and verifies leak testing system 100 status before actuating electronic latches 1100A-B. If access is granted or denied, the UI logs the event, including user credentials and timestamp, into the leak testing system 100 audit log. In the event of power failure, a fail-secure design ensures that the enclosure remains locked, while a secondary mechanical screen latch override 202 may be available for emergency access. Sensors integrated into the latches provide real-time status feedback, restricting leak testing system 100 operation when the enclosure is open.

In some examples, the leak testing system 100 incorporates dedicated hardware that secures the enclosure through latching assemblies. In some examples, the enclosure 102 includes one or more electronic latches 1100A-B that are mechanically interlocked with the enclosure 102 frame at access points. These electronic latches 1100A-B are positioned to physically isolate certain internal components. Each of the electronic latches 1100A-B may be coupled with integrated position sensors that monitor the latch status and report any deviation from the commanded state.

In some examples, the hardware includes a control panel that houses latch control circuitry and associated power components. This panel includes a fail-secure configuration such that, in the event of a power loss, at least one pf the electronic latches 1100A-B remain engaged, maintaining the enclosure 102 in a secure state. In some examples, a physical screen latch override 202 mechanism may be integrated into the design, featuring a mechanical latch that is operable with a unique physical key or specialized tool. Communication between the control panel and the MCU 104 may be conducted via a dedicated, secure bus, ensuring that the status of the electronic latches 1100A-B and sensor feedback are relayed for audit logging and system diagnostics. In other examples, the control panel can be integrated within the MCU 104 or the backplane PCB 1400, for example.

In some examples, the access control system includes enhanced physical and mechanical security features integrated with encryption protocols to provide a fail-secure status. In some embodiments, the system employs driven physical latches within a protective outer enclosure, resistant to magnetic, electronic, or other types of attacks, ensuring security. In some examples, embedded sensors continuously monitor the state of the enclosure 102 door and communicate with the MCU 104 to verify its open, closed, or securely latched state as per the logged-in user's permission level.

In some examples, any discrepancies necessitate corrective actions before further operations can proceed, ensuring compliance with EMI shielding and test accuracy requirements. Moreover, the leak testing system may utilize encrypted passwords and usernames, processed either locally or through a centralized facility login system, with periodic updates to public and private keys for continued security. In some examples, all security-related actions may be recorded in an audit log, creating a comprehensive traceable database suitable for regulated environments. This complete circle of security also accounts for emergency scenarios, where, during power failures, fail-secure latches can only be manually overridden and such events are logged when power is restored.

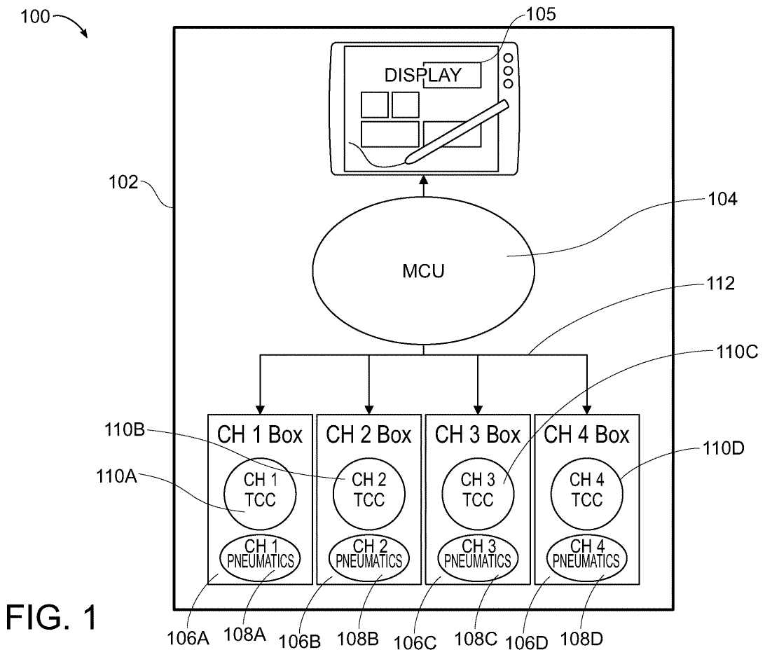

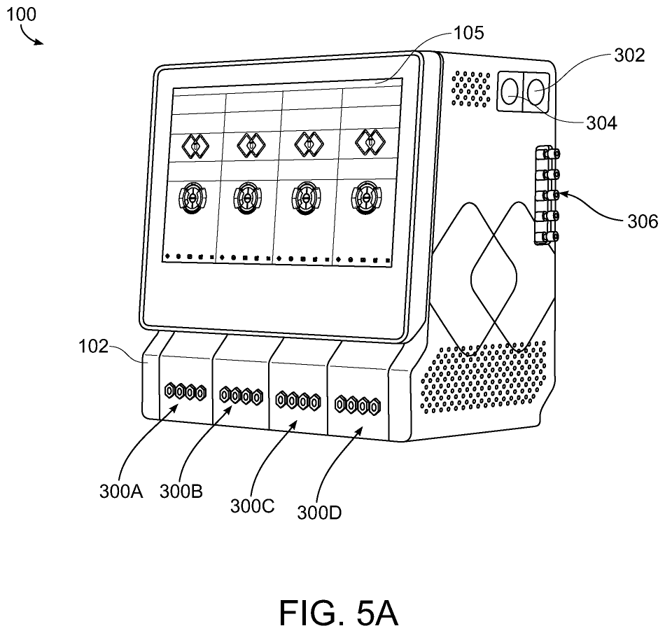

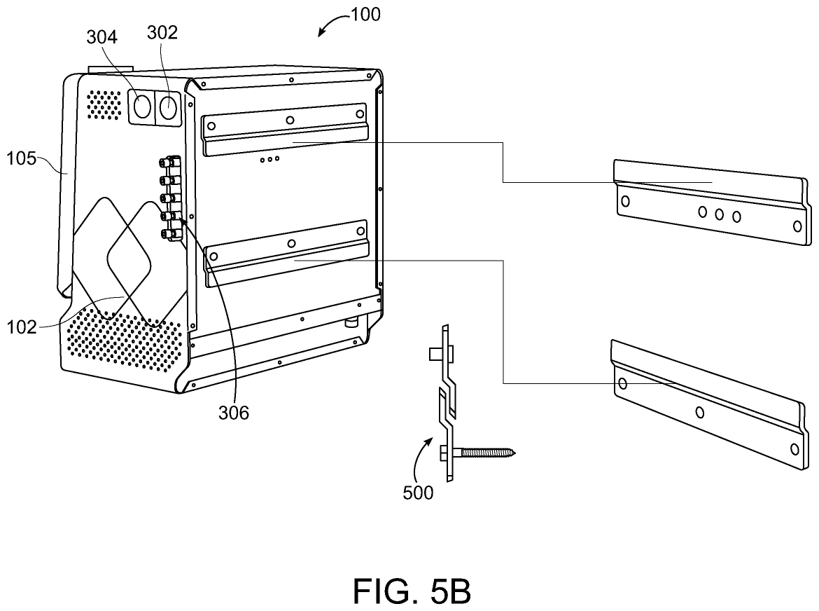

Referring now to FIG. 1, a block diagram of exemplary components of an exemplary leak testing system 100 is illustrated. The leak testing system 100 in this example includes an enclosure 102, which serves as the housing for all functional components and is provided in two form factors: a benchtop configuration and a wall-mounted configuration. FIGS. 5A and 5B depict exemplary wall-mounted configurations in some examples. In the benchtop configuration, the enclosure is positioned on a flat surface. In the wall-mounted configuration, the enclosure is designed to be affixed to a wall by sliding it into place via bracket mechanism 500, ensuring secure attachment while maintaining accessibility for service and operation.

The main control unit (MCU) 104 functions as the onboard computing system. In some embodiments, there is only one MCU per leak testing system. In other embodiments, a plurality of MCUs may be used. The MCU 104 is responsible for communication and control over all channels and global operational settings of the leak testing system 100. As shown, the display 105 comprises a user-facing touchscreen and/or multifunction gauge interface positioned on the exterior of the enclosure 102, allowing users to interact with the MCU 104, monitor test operations, and review real-time sensor updates, gauge progress bars, and step indicators that provide enhanced leak test cycle visibility. In some embodiments, the MCU 104 delivers real-time processed sensor data to the multifunction gauge interface for real-time operator insight.

Each of the channel boxes 106A-D is a subassembly associated with a testing channel within the leak testing system 100 and contains the channel-specific pneumatic components 108A-D and electronic components. The test channel controllers (TCC) 110A-D in the channel boxes 106A-D are circuit boards designed to interface with the pneumatic components 108A-D and sensors of each channel while executing the test operations for that specific channel. In the illustrated embodiment, each of the channel boxes 106A-D within the leak testing system 100 is equipped with an individual TCC 110A-D with the leak testing system 100 being capable of supporting a plurality of channels. The pneumatic components 108A-D associated with each of the channel boxes 106A-D include, but are not limited to, manifolds, sensors, regulators, and/or valves, all of which are configured to meet the specific pneumatic circuit requirements for the respective channel.

The real-time sensor data from these channels may be continuously processed and transmitted to the multifunction gauge interface to provide adaptive visual feedback, including live parameter displays and progress indicators. The pneumatic components 108A-D associated with each of the channel boxes 106A-D include, but are not limited to, manifolds, sensors, regulators, and/or valves, all of which are configured to meet the specific pneumatic circuit requirements for the respective channel.

Internal communication between the MCU 104 and each installed TCC 110A-D may be implemented via a digital communication bus 112. This communication channel may be encrypted and/or physically segregated from a customer network to enhance security. In some embodiments, USB is utilized as the primary internal communication protocol, though the leak testing system 100 is designed to support additional communication interfaces, including Ethernet and CANbus. A switch or hub can be integrated within the enclosure 102 to facilitate internal data routing. In some embodiments, peer-to-peer communication between TCCs 110A-D may be supported through Ethernet or CANbus, allowing for direct data exchange between test channels corresponding to the channel boxes 106A-D.

The communication bus 112 is not accessible from the exterior of the enclosure 102 in some examples for general system operation. However, provisions may be included to allow diagnostic or production testing of TCCs 110A-D via this communication bus 112. Additionally, the TCCs 110A-D are designed to support an Ethernet hardware driver and connector.

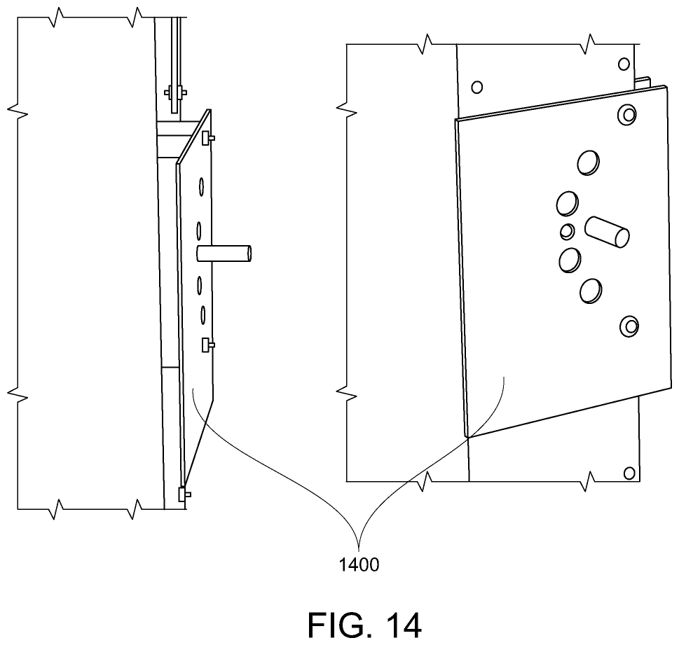

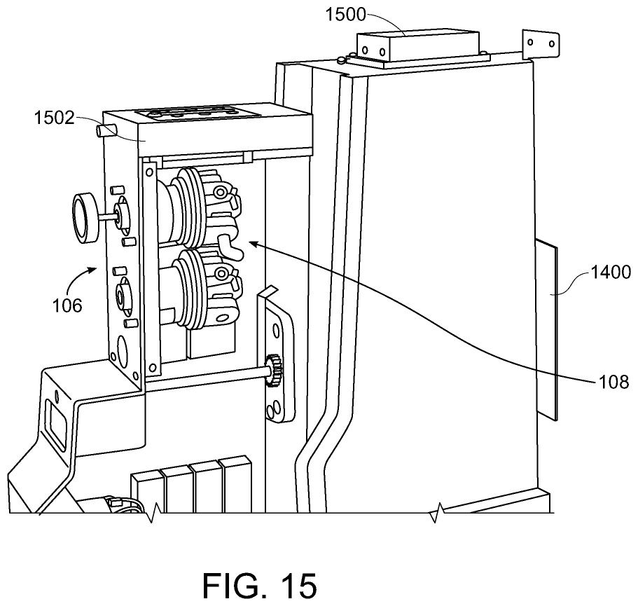

The primary enclosure 102 comprises the backplane printed circuit board (PCB) or backplane board (see FIG. 14) and a pneumatic distribution manifold (see FIG. 15). These components facilitate the rapid replacement of hardware associated with each test channel, allowing for minimal downtime during service events and allowing for flexible production scheduling. In some embodiments, a standby channel box may be substituted, thereby permitting production to resume within a short period while utilizing the same leak testing system 100. The primary enclosure 102 functions as the static element of the leak testing system 100 and, once installed, is designed to remain in place at the end-user site.

The enclosure 102 is designed to support both wall-mounted and benchtop configurations while maintaining consistency across these configurations to reduce inventory requirements, minimize complexity, and facilitate streamlined design maintenance. The enclosure 102 may be configured to allow authorized personnel to access its interior for maintenance or adjustments while remaining securely closed and locked against unauthorized access. As shown, the primary functional components, including the pneumatic components 108A-D, TCC 110A-D, and MCU 104, are housed within the same enclosure 102. The multifunction gauge interface of the disclosed technology integrates with these components by dynamically displaying live test values, step progression, and real-time trends based on continuous feedback from the leak testing system 100 sensors.

The dimensions of the enclosure are determined by market requirements and the need to accommodate channel boxes 106A-D containing all necessary circuits. A single enclosure 102 may be structured to accommodate all standard configurations. In some embodiments, the maximum enclosure size is specified as 22 inches in width, 22 inches in height, and 9 inches in depth, with minimization of the enclosure 102 dimensions prioritized where feasible.

In some embodiments, the display 105, positioned on the front face of the enclosure 102, is designed to occupy the majority of the available surface area to enhance visual appeal and maximize functional utility. A larger display 105 provides an improved user interface experience, facilitates ease of interaction, and ensures test results and operational information are clearly visible from multiple viewing angles and adjacent workstations. The multifunction gauge interface is incorporated within and/or output by the MCU 104 on this display 105, utilizing its resolution to provide operators with clear and structured real-time information, including progress bars, step identifiers, and on-target indicators.

As shown, each of the channel boxes 106A-D comprises one of the TCCs 110A-D and corresponding pneumatic components 108A-D. The modular channel boxes 106A-D facilitate efficient removal and replacement as a single unit, allowing for streamlined servicing in both field and factory environments. This approach allows for rapid maintenance and replacement, minimizing system downtime. In some embodiments, the sensor readings from each sub-assembly feed into the multifunction gauge, allowing for real-time visualization of primary and secondary sensor values, trend movements, and on-target indicators that reflect the current test step status.

In some embodiments, access to non-adjustable components within the channel box 106A-D is restricted from the end user to optimize servicing efficiency and ensure the integrity of the leak testing system 100. This approach allows a channel box 106A-D to be serviced or replaced as a single unit rather than requiring individual component adjustments.

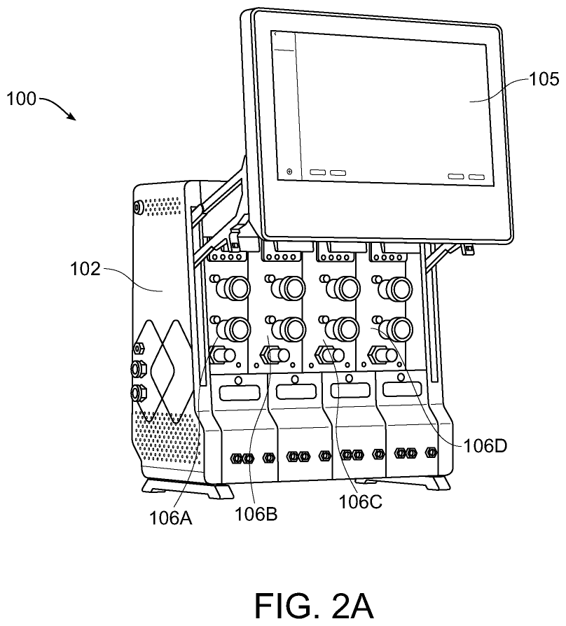

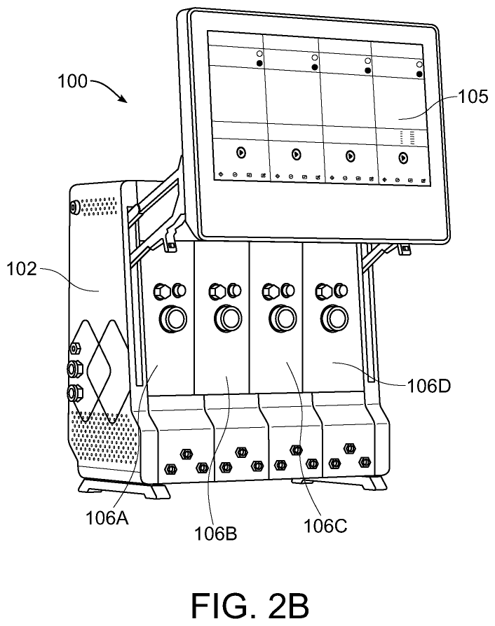

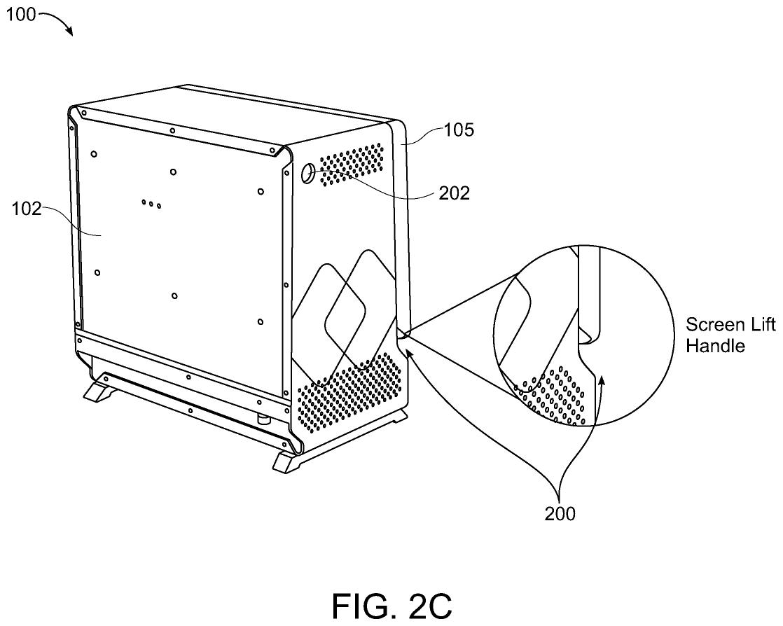

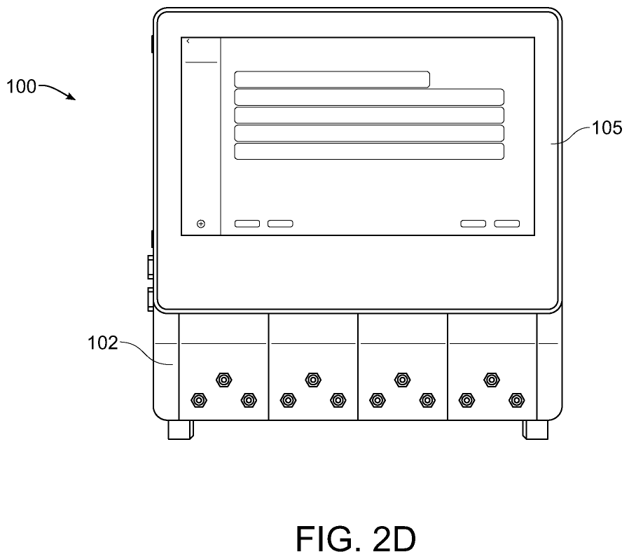

In some embodiments, various elements of the leak testing system 100 are externally accessible while the main enclosure 102 remains closed, as it is depicted in FIG. 2D. These include the touchscreen interface, start and stop buttons, USB ports, power connections, Ethernet connections, discrete digital input/output (I/O) ports per channel, and pneumatic ports, including inlets, exhausts, test ports, and coupling ports, for example, although other configurations can also be used in other examples.

In some embodiments, additional components are accessible when the enclosure is opened, as is depicted in FIGS. 2A and 2B. These include manual regulator knobs and needle valves, which remain visible during adjustments, as well as the leak master unit if an internal calibration option is selected. In some embodiments, the valving is internal, and the leak master is external and is connected to one of the test ports on the front of the corresponding one of the channel boxes 106A-D. Internal pneumatic connections between the channel boxes 106A-D and the supply/exhaust system are also accessible, which may be implemented using cabling or rack/panel connectors.

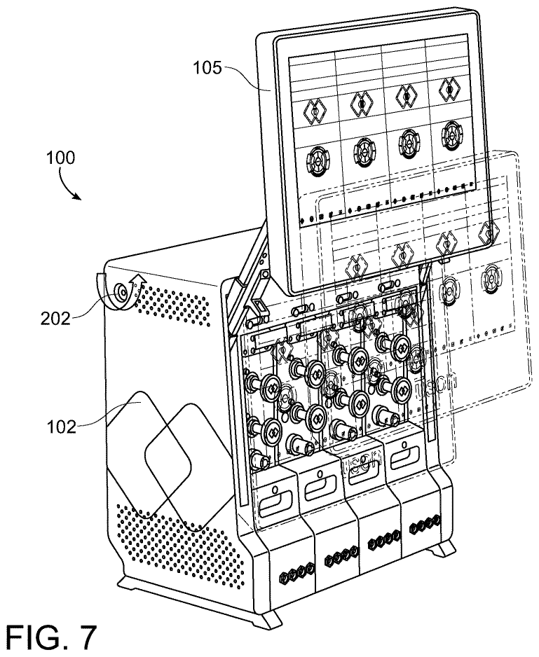

The display 105 of the leak testing system 100 can be hinged to facilitate open and closed positions whereby the display 105 provides access to the channel boxes 106A-D and substantially covers the channel boxes 106A-D, respectively. As illustrated in FIG. 2C, the leak testing system 100 can include a screen lift handle 200 that facilitates the opened and closed positions for the display 105. FIG. 2C also illustrates an optional screen latch override 202, which is also shown in FIG. 7, and releases the hinge such that the display 105 is movable about the hinge to facilitate access to the channel boxes 106A-D.

Electromagnetic interference (EMI) control and shielding is incorporated into the leak testing system 100 to mitigate radiated and absorbed electrical noise. The enclosure 102 is designed to absorb and minimize electromagnetic radiation to ensure compliance with the EMC Directive (2014/30/EU). This shielding reduces radio frequency (RF) emissions and enhances leak testing system 100 stability.

Effective thermal management helps to ensure optimal electronic performance and maintain stable test conditions, particularly for applications sensitive to thermal fluctuations, such as those involving low-volume, low-pressure, short-cycle tests or tests with variable frequency patterns that inhibit temperature stabilization. The maximum internal operating temperature of the leak testing system 100 should not exceed the rated temperature limit of the MCU (60° C. for the SBC-220) or other internal electronic devices, including SD memory, solid-state drives (SSD), and USB hubs. In some embodiments, the multifunction gauge interface receives continuous data updates from this backplane board.

To enhance thermal performance, components that generate minimal heat, such as low-wattage valves, may be selected where possible. Additionally, the leak testing system 100 may incorporate various heat dissipation mechanisms, including heat sinks and cooling fans, to maintain optimal operating conditions. In some embodiments, a warm-up program may be implemented to accommodate diverse use cases and ensure stable temperature conditions prior to testing.

The backplane PCB functions as the central power and data distribution hub for the leak testing system 100. In some embodiments, the backplane PCB includes a power inlet, switching circuitry, a serial data bus hub, and a microprocessor for controlling leak testing system 100 operations. The backplane PCB also provides a pathway for external communication of input/output (I/O) signals, facilitating efficient data transmission and power management throughout the leak testing system 100. In some embodiments, the multifunction gauge interface continuously receives processed data from the backplane PCB and MCU 104, ensuring synchronization between sensor inputs, test progression, and user display elements.

In some embodiments, the leak testing system 100 requires a single low-voltage output derived from an input power supply of 100-240V AC at 47-63 Hz, which may provide power which complies with the European Union (EU) Low Voltage Directive (LVD) power regulations. In some embodiments, the selected power supply will provide a 24V DC output. A bulkhead connector can be integrated to allow low-voltage DC input power to enter the leak testing system 100. Additionally, an externally accessible power ON/OFF switch is provided for user operation.

In some embodiments, the power-related components are arranged on the same side of the leak testing system 100 and are externally accessible from the enclosure 102. To ensure compliance with power cycling and overload protection requirements, a power-interrupting switch and fuse are integrated into an external panel. The fuse is designed to fail under fault conditions to protect leak testing system 100 components, with the appropriate fuse rating determined based on the leak testing system 100 final design. Following the power entry port, switch, and fuse, the raw DC voltage is processed through an EMI filter to remove electrical noise generated by the leak testing system 100. This filter is selected to meet specific EMC requirements and is positioned in proximity to the other input power components. Each of these power management functions is arranged in sequence before voltage is distributed to various system sub-assemblies.

The leak testing system 100 architecture may support multiple power supplies with varying capacities, allowing for the selection of a heavy-duty power supply for complex configurations. The chosen power supply must be capable of delivering sufficient power to meet the internal demands of a given leak testing system 100 configuration. In some embodiments, worst-case power consumption scenarios include valve drivers requiring up to 9.52 Amps at 24 Volts (228.5 Watts). Additional power demands from user I/O, the MCU 104, an LCD screen display 106, and other TCC 110A-D components must also be considered in the power budget. A comprehensive power estimation, accounting for worst-case and standard operating conditions, is conducted once all leak testing system 100 components have been selected.

In some embodiments, the channel boxes 106A-D serve as modular components of the leak testing system 100, incorporating the TCC 110A-D and the receiving section of the pneumatic connection manifold. The channel boxes 106A-D are configured to be easily interchangeable at an end-user site, facilitating maintenance, calibration, and modifications without requiring extensive system downtime. In some embodiments, the channel box includes various integrated components, such as the TCC 110A-D PCB, process sensors, test ports, pressure regulators, valving, a receiving manifold, connection systems, and a TCC-to-backplane interface connector. The structural design of the channel box ensures compatibility with multiple configurations. Sensor data from these components is continuously processed and relayed to the multifunction gauge interface.

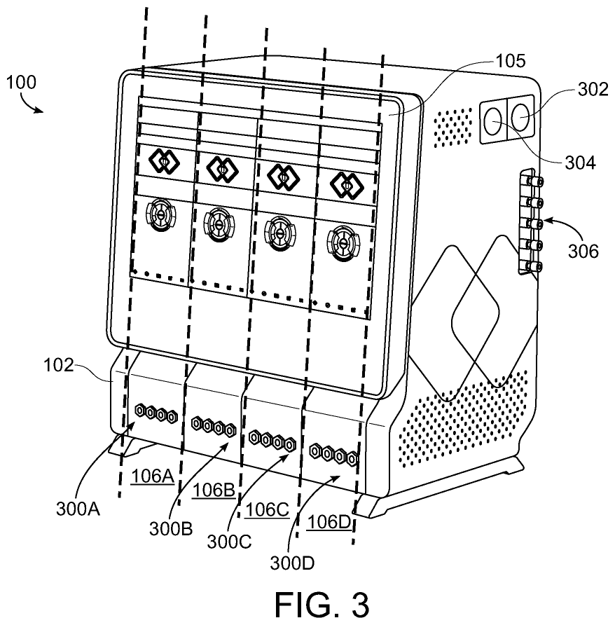

In some embodiments, the leak testing system 100 architecture can support a plurality of independent channels. For example, as depicted in FIG. 3, the leak testing system 100 architecture can support four independent channels (corresponding to channel boxes 106A-D), with each channel incorporating a dedicated TCC 110A-D, although any number of channels or channel boxes can be included in other examples.

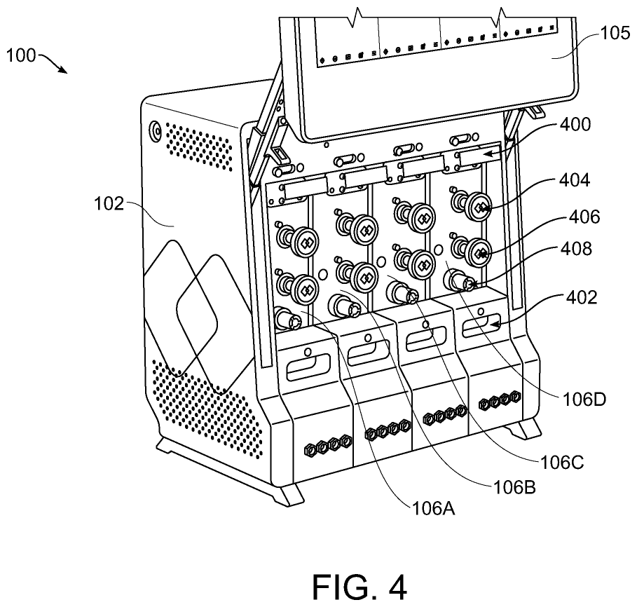

In FIG. 4, a front view of the leak testing system 100 in an opened configuration is illustrated. In this example, the display is raised or opened to reveal the channel boxes 106A-D. The leak testing system in this example also includes a channel box upper carry handle 400, a channel box lower carry handle 402, a primary regulator 404, a secondary regulator 406, and an auxiliary regulator 408. While the primary regulator 404, a secondary regulator 406, and an auxiliary regulator 408 are illustrated with reference to channel box 106D, one or more of the other channel boxes 106A-C can also include a primary regulator, a secondary regulator, and/or an auxiliary regulator 408.

Each TCC 110A-D operates independently from the others, allowing a channel to function distinctly from the other channels in both configurations and test parameters. Thus, each of the channel boxes 106A-D can have an associated set of test ports 300A-D. The leak testing system 100 in this example also includes a couple regulator 302, a couple pressure gauge 304, and a common pneumatic connection manifold 306, which is described and illustrated in more detail below.

In some embodiments, individual channels may be configured to operate under different model types and test types, allowing, for example, a gauge decay model type on one channel and a differential decay model type on another. Each channel is programmed to execute only the test procedures that correspond to its specific configuration, with sensor ranges independently assigned to each channel. In some embodiments, the multifunction gauge interface dynamically adjusts its adaptive display elements based on the specific test type, ensuring that values, progress bars, and on-target indicators reflect the most relevant test parameters in real time.

In some embodiments, the leak testing system 100 architecture allows for the implementation of separate multifunction gauge interfaces for each channel, which allows operators to monitor and interpret data from multiple channels independently and simultaneously, providing tailored visualization for each distinct test configuration. Each multifunction gauge interface can be calibrated and customized according to the specific parameters and requirements of its respective channel, thereby enhancing the accuracy and relevance of the test results presented.

The selection of a model type, test type, or operational option for a given channel is governed by predefined rules and limitations to ensure proper valve state operation and compatibility with standardized testing protocols. In some embodiments, for example, a channel utilizing a decay model type may be required to select between crack testing and sealed component testing, with the leak testing system 100 preventing simultaneous selection of both. In some embodiments, the multifunction gauge interface can dynamically adjust its display elements, including sensor readings, on-target indicators, and progress bars, based on the selected model type and operational conditions, providing operators with a clear, real-time assessment of the leak test cycle.

The leak testing system 100 supports two primary modes of operation: asynchronous and sequenced. In asynchronous operation, each channel operates independently, allowing tests to be initiated and terminated separately for each channel. This mode permits independent testing on multiple channels, wherein an operator may load a part on one channel, initiate testing, and subsequently load a part on another channel without waiting for the prior test to conclude. Each channel continues to execute its respective test without interference from other channels. The multifunction gauge interface can provide independent visual cues for each active channel, displaying real-time values and progress tracking for multiple simultaneous tests, ensuring clear differentiation between concurrent operations. Additionally, multiple multifunction gauge interfaces can be employed to reflect the real-time status and progression of each channel independently.

In sequenced operation, multiple channels may be configured to execute a predefined sequence of test programs in a synchronized manner. In some embodiments, the user may define a sequence in which all channels execute a first test program simultaneously, followed by subsequent programs in a coordinated manner. Alternatively, different channels may be assigned distinct test sequences, with one subset of channels executing a first program while another subset executes a different program upon completion of the first sequence. This mode ensures structured and synchronized testing sequences based on predefined parameters. In some embodiments, the multifunction gauge interface provides individual visual feedback for each channel, ensuring that users can track multiple independent tests simultaneously, with clear progress and result indications for each test cycle. Additionally, multiple multifunction gauge interfaces can be employed to reflect the real-time status and progression of each channel independently.

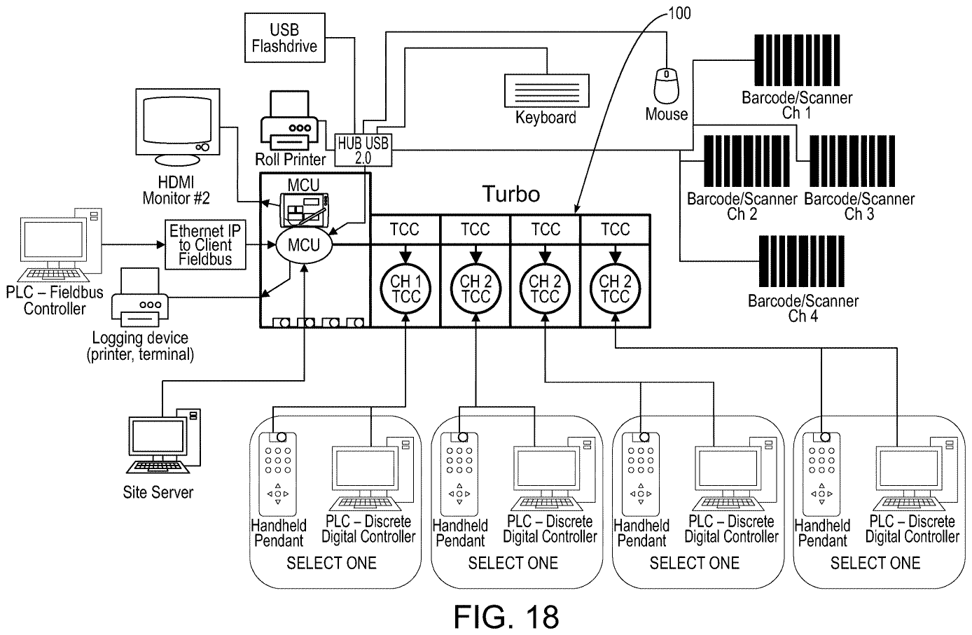

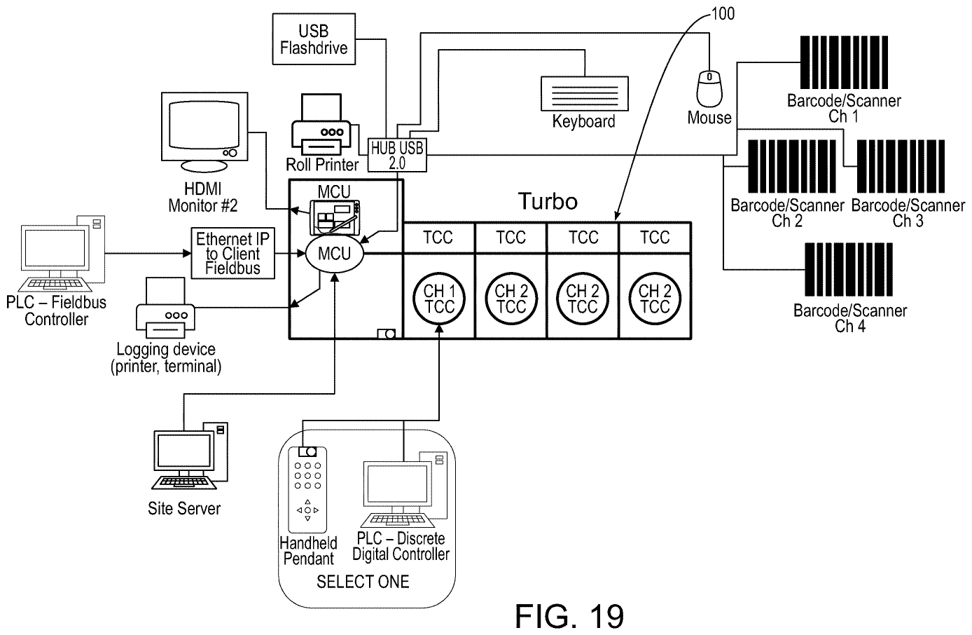

The selected mode of operation may influence the selection of external devices attached to the leak testing system 100, including barcode readers and discrete digital input/output (I/O) remote pendants. FIG. 18 illustrates the leak testing system 100 operation in asynchronous mode, while FIG. 19 depicts the leak testing system 100 configuration in sequenced mode.

The pneumatic connection manifold 306 is divided between the primary enclosure 102, which serves as the distribution unit, and the channel boxes 106A-D, which serves as the receiving unit. This configuration establishes a pneumatic interconnect between the two enclosures, allowing for efficient distribution and control of pressurized media. In some embodiments, the multifunction gauge interface integrates with this pneumatic architecture by dynamically updating its on-target indicators, progress bars, and real-time test cycle visualization based on changes in pneumatic conditions.

A common pneumatic connection manifold 306 is configured to feed all channels within the leak testing system 100. In some embodiments, selectable options allow for the inclusion of up to one high-pressure inlet capable of handling pressures greater than 150 psi and up to 1000 psi, one low-pressure inlet accommodating pressures of 150 psi or lower, and one external vacuum inlet.

In some embodiments, selectable options allow for the inclusion of a high-pressure inlet capable of handling pressures ranging from 500 psi to 1000 psi, a medium-pressure inlet capable of handling pressures ranging from 150 psi to 500 psi, a low pressure inlet capable of handling pressures ranging from 0 psi to 150 psi, an external vacuum supply, and a regulated couple air supply capable of handling pressures of up to 125 psi.

Each channel is equipped with an independent pneumatic supply circuit, including its associated components. In some embodiments, each channel may include one main regulator, which may be either manually adjusted or electronically controlled, one auxiliary manual regulator, and an internal vacuum generation circuit.

In the illustrated embodiment, the system architecture supports up to four high-resolution ADCs per channel, facilitating precise pneumatic measurements. The pneumatic configuration supports standard and high-flow valving, with pressure ranges extending from vacuum to 1000 psi and flow capacities reaching up to 100 liters per minute (Lpm). In some embodiments, the pneumatic configuration can support pressure ranges exceeding 1000 psi and flow capacities exceeding 100 Lpm. In some embodiments, up to two coupling valves per channel may be controlled. Sensor data from these pneumatic components is continuously transmitted to the multifunction gauge interface. In some embodiments, up to two coupling valves per channel may be controlled.

The leak testing system 100 provides external pneumatic ports, with the number and function of test ports varying according to the model type, test type, and selected configuration options. In some embodiments, two coupling ports, corresponding to two coupling valves per channel, may be supported.

The distribution manifold, located within the primary enclosure 102, is configured with input ports that accommodate multiple pressure levels and flow directions. This distribution manifold integrates a mechanism that allows multiple valves to be actuated simultaneously using a singular tooling motion. This feature facilitates the controlled supply and venting of pressure to and from the channel boxes 106A-D as part of the connection and ejection process. All available pressure levels are routed through this distribution manifold. Additionally, interlocks are incorporated to prevent unintended or unsafe operation.

The receiving manifold, housed within each of the channel boxes 106A-D, is responsible for distributing the applied pressures received from the distribution manifold. Any pressures not required for a specific test are blocked within the receiving manifold. This receiving manifold is also designed with structural provisions to secure its attachment to the distribution manifold, ensuring a leak-tight seal. Upon disengagement, the receiving manifold triggers the closing of the distribution manifold valves and vents any residual downstream pressure, thereby facilitating a controlled and safe disengagement process. In some embodiments, the closing/venting of the distribution manifold is completed before undocking the receiving manifold. In some embodiments, the user first de-energizes the distribution manifold, then the user can disengage the receiving manifold.

The TCC 110A-D PCBs are integrated into each channel box 106A-D and are responsible for managing all functional operations of the channel box 106A-D and the associated testing processes. The primary functions of the TCCs 110A-D include receiving and processing sensor inputs, performing A/D conversion, managing internal and external isolated input signals, and high-side drivers. Additionally, the TCCs 110A-D are equipped with a microprocessor, firmware storage, and interfaces that allow for the transmission of power and data between the TCCs 110A-D and the backplane PCB. The TCCs 110A-D serve as the fundamental operational unit of the leak testing system 100, executing all test-related functions while exchanging data bidirectionally with the MCU 104. In some embodiments, sensor data processed by the TCCs 110A-D may be continuously fed to the multifunction gauge interface, providing real-time feedback on pneumatic parameters, including pressure stability, flow rates, and valve actuation status.

The TCC 110A-D PCBs are configured to operate independently within each channel, operating the corresponding valves, electronic regulators, and sensors. In some embodiments, the TCC 110A-D PCBs are designed to minimize activation energy and redesign time, enhancing leak testing system 100 efficiency. This independence allows the multifunction gauge interface to display unique test cycle data for each channel.

The TCC 110A-D PCBs include a power-on self-test (POST) functionality to detect TCC 110A-D properties and determine the number of attached TCCs 110A-D PCBs. To ensure the integrity and security of firmware execution, the leak testing system 100 may implement error correction mechanisms or cyclic redundancy checks (CRC) for validation. Additionally, the leak testing system 100 provides indications of successful boot completion and communication status via USB, RS232 messaging, or onboard LED indicators.

Each TCC 110A-D PCB is assigned a unique identifier, such as a serial number or a universally unique identifier (UUID). If an Ethernet port is present, the media access control (MAC) address may also be utilized. This identifier is programmed into the TCC 110A-D PCBs prior to operation to permit the MCU 104 software to identify, enumerate, and correctly associate each TCC 110A-D with the appropriate channel. In some embodiments, the programming of TCC 110A-D identification may be completed by a contract manufacturer (CM), with potential support provided by engineering or production teams during the initial setup phase.

In some embodiments, the leak testing system 100 supports a variety of valve configurations, with power consumption per channel depending on the number of valves and test parameters. Across different test scenarios, the power demand per channel typically ranges from 14 W to 57 W, with current draw ranging between 0.58 Å and 2.38 Å at 24V DC. Higher-powered configurations, such as high-pressure burst testing, require the upper end of this range. The leak testing system 100 can accommodate this range while ensuring efficient power distribution and thermal management.

In some embodiments, the TCCs 110A-D are required to support analog interfaces for measuring and controlling devices that utilize analog input and output signals. The characteristics of these interfaces, including resolution, accuracy, voltage and current range, gain, and filtering, are determined by the leak testing system 100 specifications. Since the TCCs 110A-D are digital control systems, analog interfaces are implemented using analog-to-digital (A/D) and digital-to-analog (D/A) conversion components.

The leak testing system 100 is configured to support a range of pressure sensors to ensure compatibility with various testing applications. In some embodiments, at a minimum, the system is designed to support a range of gauge pressure sensors and differential pressure sensors. Flow sensors are incorporated to facilitate precise measurement of fluid flow during testing operations. In some embodiments, the leak testing system 100 supports a range of mass flow sensors selected based on their prevalence and demonstrated performance in similar applications.

The TCCs 110A-D are further configured to electrically interface with force sensors to allow force measurement in applicable testing scenarios. In some embodiments, alternative force sensors that utilize the same millivolt analog input may also be supported, subject to further determination based on leak testing system 100 design considerations.

The leak testing system 100 is designed to support multiple temperature measurement points to monitor and compensate for temperature variations during testing. In some embodiments, a diagnostic temperature measurement is incorporated within the TCCs 110A-D, with a requirement that it does not necessitate a high-resolution ADC. Additionally, an internal temperature measurement is provided within the channel boxes 106A-D, optionally located within the manifold or another critical area, also without the need for a high-resolution ADC. Further, an external temperature measurement is implemented, with a preference for digital sensor data acquisition via an RS485 communication interface.

The leak testing system 100 architecture includes support for electronic pressure regulators (EPR) and electronic flow controllers, with each of the TCCs 110A-D capable of accommodating one such device per channel. The operation of these components is achieved through control via an analog voltage signal, which is generated using a digital-to-analog (D/A) converter and an amplifier. In some embodiments, at a minimum, each of the TCCs 110A-D is configured to electrically support various electronic pressure regulators.

Each of the TCCs 110A-D is configured to support additional digital signals to enhance system safety, monitoring, and operational efficiency in some examples. In some embodiments, the TCCs 110A-D include a pressure switch that detects insufficient pilot air supply or a loss of air supply. This pressure switch is operably connected to a safety valve, which functions to lock air within the couple circuit and prevent unintentional state changes. The implementation of this safety mechanism may be achieved through hardware or software, with hardware-based solutions being preferable from a safety perspective.

Furthermore, in some embodiments, the leak testing system 100 incorporates a spool position sensor within the combination valve assembly. This sensor is configured to detect instances where the equalization valve fails to actuate properly, thereby generating an error signal that is communicated to the operator. Additionally, provisions may be made to support at least one sensor with a digital interface via an RS485 communication protocol. This configuration may facilitate external sensor integration, such as temperature compensation measurements or the transmission of sensor data from an external processing unit.

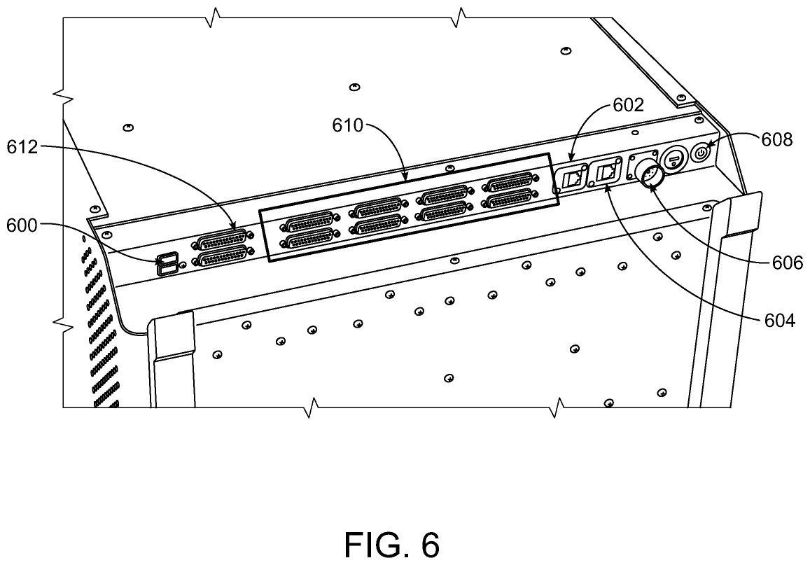

A rear view of an exemplary leak testing system 100 is illustrated in FIG. 6. The leak testing system 100 in this example includes USB ports 600, an RJ45 TCP-/IP input 602, an RJ45 PLC bus 604, a power supply connector 606, and a power switch 608. In some embodiments, as depicted in FIG. 6, the leak testing system 100 provides 16 discrete channel-specific (for each channel) I/Os 610 plus 16 discrete I/Os 612 for global control. The discrete digital I/O is based on a 24V DC hardware interface implementation and is externally accessible to the operator. These digital inputs and outputs may dynamically interface with the multifunction gauge interface, allowing for real-time updates of test progress, valve actuation, and regulator adjustments within the graphical display. The digital I/O may be utilized by external devices, including PLCs or remote pendants, to facilitate program and sequence selection, initiate and abort tests, and communicate test results and leak testing system 100 status.

In one embodiment, the leak testing system 100 provides fixed I/O assignments for predefined functions. However, in some embodiments, a customizable configuration may be implemented, allowing the end user to modify the default I/O assignments. The leak testing system 100 may be configured to support program and sequence selection, using a binary-coded decimal (BCD) format or using a binary format.

Each output in the exemplary leak testing system 100 is configured to operate at 0.7 Å, with a total output capacity of 4 Å. These outputs are implemented as high-side 24V DC sources with integrated protection to ensure leak testing system 100 stability and prevent overcurrent conditions. In some embodiments, when BCD program selection inputs are user-defined, the leak testing system 100 is configured to manage and control the assigned code weighting. This may be accomplished by automatically assigning BCD outputs in an ascending order (e.g., BCD 1, BCD 2, etc.), or by providing a secondary field allowing the user to define the assignment of BCD 1 through BCD 8. The salvage output selection is not required in the present implementation. However, the leak testing system 100 is designed to support alert outputs for operational status and fault indication. In some embodiments, a custom configuration option may be provided, which includes an “Apply Defaults” feature, allowing users to revert to predefined settings.

In some embodiments, the system further includes a timer verification output, which is implemented as a 24V high-side sourcing output to ensure consistency with other output configurations. The reliability of all input and output connections is a critical aspect of overall leak testing system 100 performance. Therefore, the leak testing system 100 incorporates a robust connector design with built-in cable support and strain relief to enhance durability and maintain secure electrical connections. To support these functionalities, a total of twenty-five contacts is required for each standard I/O configuration, including both power and ground connections, resulting in 25 input signals and 25 output signals. In some embodiments, if the input and output connections are separated into distinct connectors, it may be advantageous to implement output signals on a socketed panel component, while input signals are connected via pin-type interfaces to facilitate reliable and secure connectivity.

The following input/output assignments are provided as examples and are intended to be non-limiting. These configurations can be adjusted and customized as needed based on specific user requirements and system needs.

TABLE 1
Inputs

| # | Standard: Default | Custom: Default Selection |
|---|---|---|
| Input | Selection - Fixed | (Fixed or User defined) |
| 1 | Start | Start (Fixed) |
| 2 | Start Enable | Start Enable (Fixed) |
| 3 | Abort | Abort (Fixed) |
| 4 | Program Select 1 | Program Select 1 (User Defined) |
| 5 | Program Select 2 | Program Select 2 (User Defined) |
| 6 | Program Select 3 | Program Select 3 (User Defined) |
| 7 | Program Select 4 | Program Select 4 (User Defined) |
| 8 | Program Select 5 | Program Select 5 (User Defined) |
| 9 | Program Select 6 | Program Select 6 (User Defined) |
| 10 | Program Select 7 | Program Select 7 (User Defined) |
| 11 | Program Select 8 | Program Select 8 (User Defined) |
| 12 | Disabled | Disabled (User Defined) |
| 13 | Disabled | Disabled (User Defined) |
| 14 | Disabled | Disabled (User Defined) |
| 15 | Disabled | Disabled (User Defined) |
| 16 | Disabled | Disabled (User Defined) |

TABLE 2
Input Select Options

| Option | Controlled By | Ch # |
|---|---|---|
| Disabled | — | — |
| Start | Channel/Sequencer | —/x |
| Start Enable | Channel/Sequencer | —/x |
| Stop | Channel/Sequencer | —/x |
| Abort | Channel/Sequencer | —/x |
| BCD X Selection | Channel/Sequencer/Group | —/x |

TABLE 3
Outputs

| # | Standard: Default | Custom: Default Selections |
|---|---|---|
| Output | Selections - Fixed | (Fixed or User defined). |
| 1 | Alarm | Alarm (user defined) |
| 2 | Ready | Ready (User defined) |
| 3 | EOC | EOC (User Defined) |
| 4 | Timer | Timer (User Defined) |
| 5 | Pass | Pass (User Defined) |
| 6 | Fail | Fail (User Defined) |
| 7 | Disabled | Program Specified (User Defined) |
| 8 | Disabled | Program Specified (User Defined) |
| 9 | Disabled | Program Specified (User Defined) |
| 10 | Disabled | Program Specified (User Defined) |
| 11 | Disabled | Program Specified (User Defined) |
| 12 | Disabled | Program Specified (User Defined) |
| 13 | Disabled | Program Specified (User Defined) |
| 14 | Disabled | Program Specified (User Defined) |
| 15 | Disabled | Program Specified (User Defined) |
| 16 | Disabled | Program Specified (User Defined) |

TABLE 4
Output Selection Options

| Option | Controlled By | Ch # | Type. |
|---|---|---|---|
| Disabled | — | — | |
| Alarm | Channel | — | |
| Ready | Channel/Sequencer | —/x | |
| EOC | Channel/Sequencer | —/x | |
| Timer Verification | Channel | — | |
| Result | Channel | — | Pass, Fail, Gross, Fast |
| | | | Flush, Roll Over, Step |
| | | | Pass, Step Fail, Link |
| | | | Pass, Link Fail |
| | Sequencer | X | Group Pass, Group |
| | | | Fail, Seq Channel |
| | | | Pass, Seq Channel |
| | | | Fail, Seq Pass, Seq |
| | | | Fail. |
| Program Specified | Channel/sequencer | X | BCD X Selection, |
| | | | where V is 0 to 9 |
| Alarm | Channel | X | |
| Ready | Channel/Sequencer | —/x | |
| EOC | Channel/Sequencer | —/x | |
| Pass Mark | Channel/Sequencer | —/x | |
| Consecutive Reject | Channel/Sequencer | —/x | |
| Couple | Channel/Sequencer | —/x | Couple 1, couple 2, |
| | | | couple 3, couple 4 |
| Alert | — | — | |

Communication between the TCCs 110A-D and the MCU 104 is implemented via USB in some examples. Additionally, support is provided for Controller Area Network (CAN) bus and Ethernet communication, allowing for future development and expansion. The system architecture includes provisions for integrating components necessary to support all three communication protocols. An internal USB adapter is required to facilitate connectivity; however, a host function is not necessary for this implementation.

Automatic detection of channel box 106A-D locations is incorporated through a hardware-based mechanism. The physical arrangement of channels is fixed such that Channels 1, 2, 3, and 4 are aligned sequentially from left to right, corresponding to the touchscreen display's channel numbering. The leak testing system 100 is configured to automatically identify the connection position of each of the channel boxes 106A-D, and consequently, each TCC 110A-D, within the enclosure 102. Upon detection, the assigned channel position is displayed to the user through the system interface.

The firmware for each of the TCCs 110A-D is stored and executed locally on the TCC 110A-D hardware. In some embodiments, the firmware is stored in either a microSD card or serial flash memory. To ensure data security and prevent unauthorized modifications, the firmware requires encryption. The leak testing system 100 architecture is designed such that, in future implementations, the firmware may be adapted to support additional capabilities.

A menu-driven manufacturing test capability is provided to verify the proper operation of each of the TCCs 110A-D before it is connected to the MCU 104. The manufacturing test functionality includes a user-selectable mode that allows for detailed validation of all critical TCC 110A-D functions as well as any additional tests required by system engineering teams. These tests may include, but are not limited to, memory integrity verification, power stability assessment, and functional validation of analog and digital input/output interfaces.

To facilitate manufacturing and validation, dedicated test equipment, including test boxes, software tools, and additional fixtures, are utilized. The testing process supports connection through either the USB or RS-232 interface, allowing for flexible configuration and debugging. The manufacturing test system is designed to verify all relevant system-level performance parameters, including power supply voltage stability, ADC readings, solenoid valve activation states, and the toggling functionality of critical control signals.

The MCU 104 is configured to facilitate the operation, monitoring, and management of the leak testing system 100. As shown, the MCU 104 incorporates a touchscreen display 105 that provides a user interface for test configuration and setup information associated with the TCCs 110A-D. The MCU 104 includes software-based controls for initiating and terminating test operations. A single serial port may be implemented as a 9-pin D-type connector to allow data logging and, if necessary, debugging operations.

The MCU 104 features an Ethernet-based IT network connection that supports program import/export functionality and allows test results to be logged to an external Windows-based server. Furthermore, a dedicated industrial network connection is provided for communication with a PLC over a fieldbus protocol. This connection allows remote access to data, facilitates program and sequence selection, allows for the initiation and termination of tests, and provides result and status outputs to external control systems. The MCU 104 also includes two externally accessible USB ports 600.

The exemplary leak testing system 100 architecture permits multiple selections for results logging, including but not limited to logging via USB storage devices, network-based storage, or a serial connection. In some embodiments, the MCU 104 is configured to support an external secondary monitor, which can be connected via an HDMI port, allowing for the mirroring of the primary display for enhanced visualization and operational monitoring.

The MCU 104 may support the use of barcode scanning devices to facilitate test initiation, program selection, and data input. In some embodiments, either a single barcode scanner is utilized for the entire leak testing system 100, or multiple barcode scanners (up to four, one per channel) are implemented. Where multiple barcode scanners are employed, a unique prefix identifier, such as ‘A’, ‘B’, ‘C’, or ‘D’ is assigned to each scanner to differentiate the corresponding test channel.

The leak testing system 100 architecture supports the storage of multiple sequences within the MCU 104, with no defined limit of distinct sequences that may be configured and stored. In some embodiments, the MCU 104 is capable of storing up to and exceeding, for example, 1,000 distinct test programs and an equivalent number of test sequences. Functionality is provided to allow for the duplication and modification of existing programs. The MCU 104 is further designed with an expansion slot, which may be configured as either a mini-PCIe or M.2 slot, to support potential future system enhancements requiring additional PC-based cards.

External communication from the MCU 104 is facilitated through multiple interfaces. The primary user interface includes a front-panel touchscreen display that provides access to start/stop controls, test programs, and configuration settings. The touchscreen is designed with an optically bonded protective glass overlay and incorporates capacitive touch functionality, including gesture-based controls. In some embodiments, the display 105 specifications range from 18.5 inches to 21.5 inches in diagonal measurement, with a resolution of 1920×1080 pixels and an aspect ratio of 16:9.

In some embodiments, the MCU 104 includes a dedicated Ethernet port for industrial fieldbus communication, establishing connectivity with external PLC systems. This interface supports fieldbus communication protocols, allowing for seamless integration with industrial automation systems. Additionally, a translation device may be employed to facilitate communication with other fieldbus protocols. In such embodiments, the MCU 104 transmits data via Ethernet/IP or Modbus TCP to an intermediate converter, which subsequently translates the communication protocol to match the PLC's required format, such as Profibus, Profinet, EtherCAT, or DeviceNet.

In some embodiments, Modbus TCP/IP may be natively supported. The inclusion of Modbus TCP/IP may facilitate compatibility with other communication protocols while maintaining system performance. Furthermore, this implementation may enhance backward compatibility with existing systems that rely on Modbus communication.

In some embodiments, a dedicated Ethernet port is provided for connectivity to an IT network, allowing for the logging of test results and the export of data to a Windows-based server. The functionality of the Ethernet connection, including features related to data transfer and security, may be selectively enabled or disabled through software configuration settings.

A single externally accessible RS232 serial port is included to support customer requirements for connecting a serial printer or terminal, allowing for real-time viewing or printing of test results. The exemplary leak testing system 100 also incorporates two externally accessible USB 3.0 ports 600 on the enclosure, which facilitate connectivity with external devices for data transfer, software updates, and peripheral expansion.

In some embodiments, provisions may be included to support future capabilities related to exporting, viewing, and potentially modifying system data, including test programs and configuration settings, through a dedicated application or viewer. The system can also be designed to accommodate an external USB hub, which may be either optional or user-supplied, thereby increasing the number of available USB ports when required.

The installation process for a channel box 106A-D into an empty bay follows a structured sequence to ensure proper alignment and secure connection. Initially, the channel box is positioned onto a guide block and pushed rearward. Upon reaching a damper, alignment pins are piloted into the channel boxes 106A-D. Continued rearward movement proceeds until a firm stop is encountered. At this stage, a tool is utilized to rotate a connection fastener located on the handle of the channel box 106A-D, drawing it fully into the bay. The fastener is rotated until hand-tightened to ensure a secure mechanical connection. Subsequently, the same tool is used to rotate the pneumatic connection actuator, positioned at the upper left of the channel box, until it reaches its stop position. This action facilitates the connection of the pneumatic manifolds and ensures full engagement of the channel box 106A-D box within the bay.

Following the mechanical and pneumatic engagement, the pneumatic supply is activated using the same tool to actuate the distribution manifold supply valve. This valve is interfaced via a mating connection situated above the one of the channel boxes 106A-D at the top of the primary enclosure. Once actuated, pressure is applied to the one of the channel boxes 106A-D, allowing it to function within the leak testing system 100. Upon completion of these steps, the one of the channel boxes 106A-D is fully installed, securely connected, and fully energized for operation.

The disclosed leak testing system 100 is designed to serve various markets, including but not limited to medical devices, industrial applications, packaging, automotive and transportation, and electric vehicle manufacturing. The system is capable of operating with multiple testing media, including air and nitrogen, among other suitable alternatives. The leak testing system 100 supports a diverse range of test types, including but not limited to pressure decay, mass flow, occlusion testing, and seal creep testing. These testing capabilities are configured to address complex and varied application requirements.

The disclosed leak testing system 100 enhances conventional product offerings by extending functionality and improving automation integration. The measurement engine is expanded to accommodate additional test techniques suitable for complex applications. Automation features are improved to provide greater configuration flexibility, facilitating seamless system integration. Data analytics capabilities are enhanced to support robust analysis, while the user experience is optimized to ensure scalability across research and development (R&D) environments and high-volume production settings.

The measurement engine is configured to support an increased number of test types, including differential pressure decay testing. In some embodiments, the leak testing system 100 is designed to accommodate extended applications involving high-pressure testing exceeding 1000 psi, high-flow testing, and distinct test types per channel. Additional sensor capabilities are incorporated, with expanded sensor ranges and increased sensitivity to ensure precise measurements.

The exemplary leak testing system 100 architecture supports synchronous and asynchronous operation while maintaining digital I/O functionality. In some embodiments, the fieldbus communication system is upgraded from Modbus to a faster, modern Ethernet/IP-based or other fieldbus architecture. The modular design is implemented in both wall-mounted and benchtop form factors.

The disclosed technology extends functionality and improves automation integration for leak testing systems. The multifunction gauge interface provides a high-density data visualization platform that allows users to interpret test cycle trends, compare live sensor readings, and anticipate results in real time. Data analytics capabilities are enhanced to support robust analysis, while the user experience is optimized to ensure scalability across research and development (R&D) environments and high-volume production settings.

The automation capabilities of the exemplary leak testing system 100 include multiple modes of operation, such as sequence mode, asynchronous mode, and synchronous mode. The modular architecture supports different form factors, including wall-mounted and benchtop configurations. Improved I/O control is incorporated, along with native fieldbus integration to facilitate enhanced automation and connectivity. In some embodiments, the multifunction gauge interface can dynamically adjust its graphical representation based on the selected automation mode, providing clear and structured feedback to ensure operators can easily monitor test sequencing, concurrent test execution, and cycle progress.

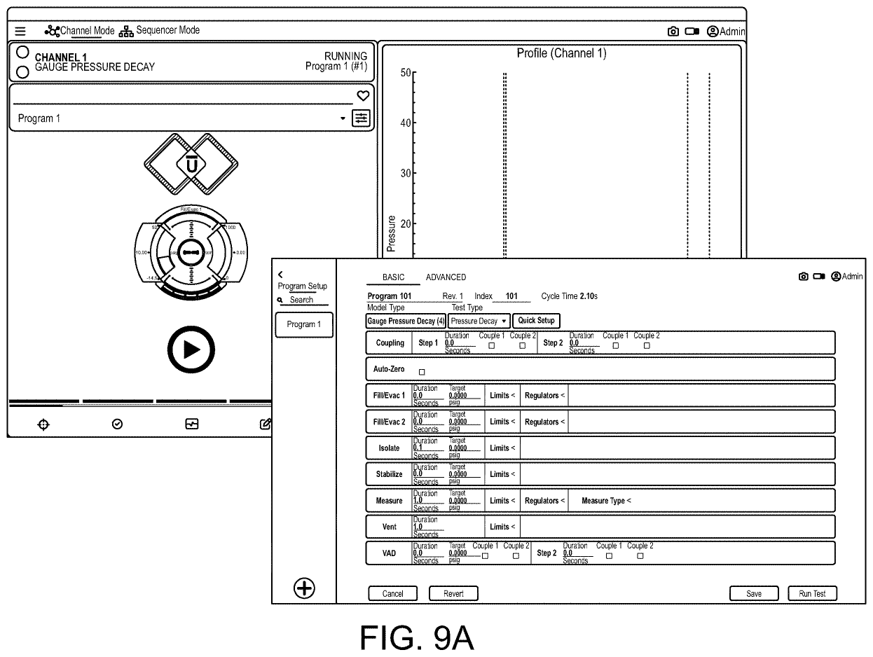

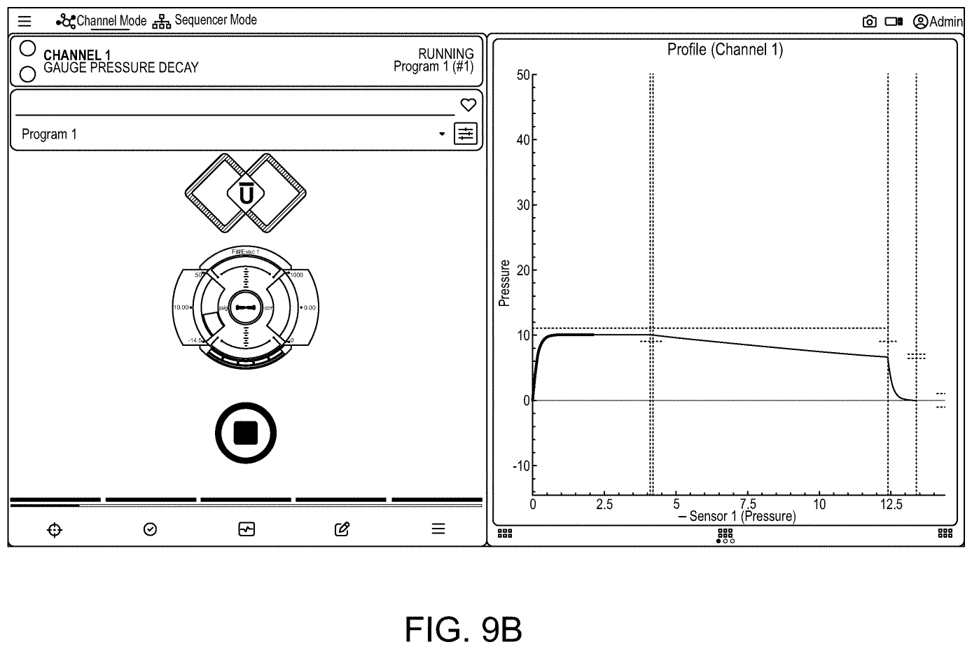

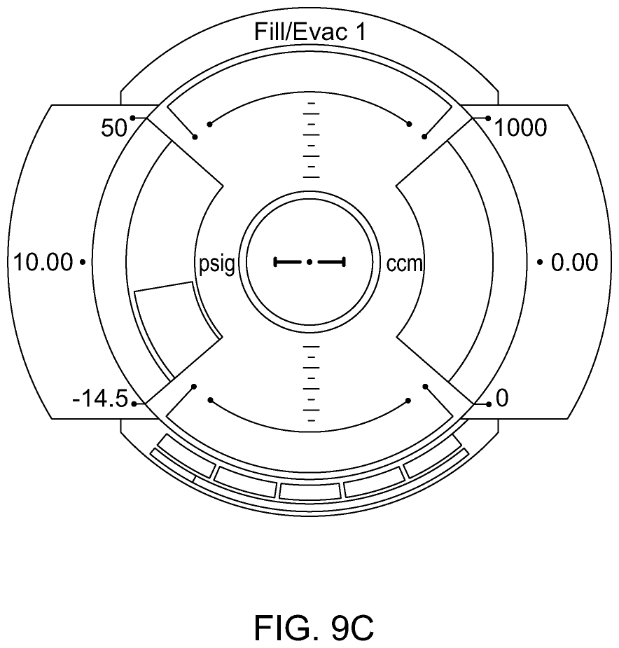

The data analytics functionality may be designed to support pneumatic channel independence and expanded graphing capabilities, allowing for advanced data visualization and interpretation. The user interface, as depicted in FIGS. 9A-C, is developed to provide an enhanced user experience, featuring a flexible home page with configurable widgets and a large multi-touch display. The multifunction gauge may be integrated within this interface to ensure that test indicators, including sensor trends, progress bars, and step indicators, are clearly visible and easily interpretable in real-time. The multifunction gauge interface utilizes real-time ADC data, digital I/O status, and pneumatic regulator feedback to enhance operator awareness and improve test cycle interpretation. The setup process is streamlined to improve efficiency, while plot functionality is enhanced to facilitate test data review and analysis. The leak testing system 100 architecture is restructured to support independent channels, thereby increasing operational flexibility.

In some embodiments, the leak testing system 100 includes a larger touchscreen display 105 to provide an optimized user interface. The restructuring of the architecture ensures improved support for independent channel operations. The home screen configuration is made more flexible, allowing for customization based on user preferences. The program setup process is simplified and streamlined to enhance overall usability, while the multifunction gauge interface serves as a central information hub, delivering real-time, high-density data visualization throughout test execution.

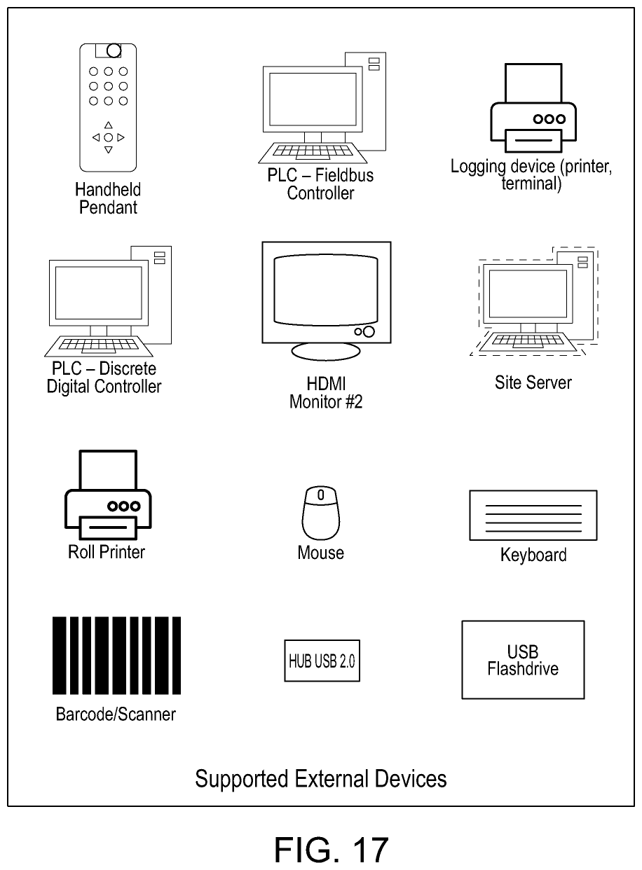

FIG. 17 illustrates exemplary supported external devices that can be connected to the leak testing system 100, encompassing multiple categories of devices that facilitate enhanced functionality and leak testing system 100 integration. The leak testing system 100 supports external devices interfacing through USB, digital I/O connections, Ethernet, HDMI, and RS232 serial ports. These devices allow for advanced user interaction, data logging, test initiation, and automation integration.

In some embodiments, a barcode reader is implemented for scanning data, selecting programs, and initiating test procedures. The barcode reader configuration supports two primary options: a single reader per tester or individual readers assigned per channel. When a single barcode reader is used per tester, the signal is transmitted via USB to the MCU 104. Alternatively, when each channel is assigned a dedicated barcode reader, the signal is routed through a USB hub to the MCU 104. The MCU 104 is configured to recognize and associate each barcode reader's signal with the corresponding channel based on its unique identifier.

A USB flash drive may be supported for transferring data to and from the leak testing system 100. This includes, but is not limited to, result logging, license updates, and software upgrades. In some embodiments, a keyboard and mouse may be connected to facilitate user interaction with the leak testing system 100 user interface. Additionally, an external USB hub may be supplied by the user if the number of USB-connected devices exceeds the two externally available USB ports on the enclosure. A USB printer may be supported by the operating system's generic driver and may be connected as an optional device. This printer allows for the direct printing of test results from the leak testing system 100.

The leak testing system 100 may support remote pendants that may be utilized for program and/or sequence selection, test start/stop functionality, and status indication. In asynchronous operation, a remote pendant may be assigned per channel. In such embodiments, the TCC 110A-D updates pass/fail outputs when configured, allowing pass/fail indicators to visually reflect the status of the connected channel. In sequenced operation, a single remote pendant may be assigned to leak testing system 100, connected to the leak testing system 100 global I/O 612. The pass/fail outputs of the sequences are updated accordingly and may be configured to display the sequencer's pass/fail status.

In some embodiments, a PLC may be connected directly to the leak testing system 100 discrete digital I/O 610. This configuration allows external PLCs to initiate and terminate tests, select programs, and retrieve status information, providing an alternative automation control method. In some embodiments, a PLC may be utilized for automation control by interfacing directly with the TCCs 110A-D through discrete digital I/O connections. The PLC may be configured to initiate and terminate test procedures, select programs, and retrieve status information from the leak testing system 100. This functionality allows for seamless integration of the leak testing system 100 with industrial automation infrastructure.

The illustrated leak testing system 100 architecture includes externally accessible Ethernet ports to facilitate data communication and control. A first Ethernet port is designated for connection to an external site server, while a second Ethernet/IP port is allocated for fieldbus communication. To prevent misconfiguration, the two ports are physically distinct and may be labeled accordingly. For example, a first Ethernet port may allow for connectivity to a customer's internal site server or network. This connection supports result logging, database import and export, and other data exchange functionalities. In some embodiments, direct transmission of test data to a network printer may not be supported in the initial implementation phase. For example, a second Ethernet port may be allocated for fieldbus communication with a PLC. This connection allows a PLC to transmit and receive operational commands, monitor test execution, and retrieve test results. The fieldbus communication protocol may be based on Ethernet/IP, ensuring compatibility with standard industrial automation systems.

The leak testing system 100 may further include an externally accessible HDMI port, which is configured to support mirrored display functionality for demonstration purposes. In some embodiments, this HDMI output may be utilized exclusively for sales demonstrations, allowing the primary user interface display 105 to be replicated on a secondary monitor. Additionally, the leak testing system 100 may incorporate an externally accessible RS232 serial port for data logging and printing applications. In some embodiments, this port may be used to connect a serial printer or terminal, allowing real-time viewing and printing of test results. The RS232 interface provides a standardized method for external devices to access test data in a structured format.

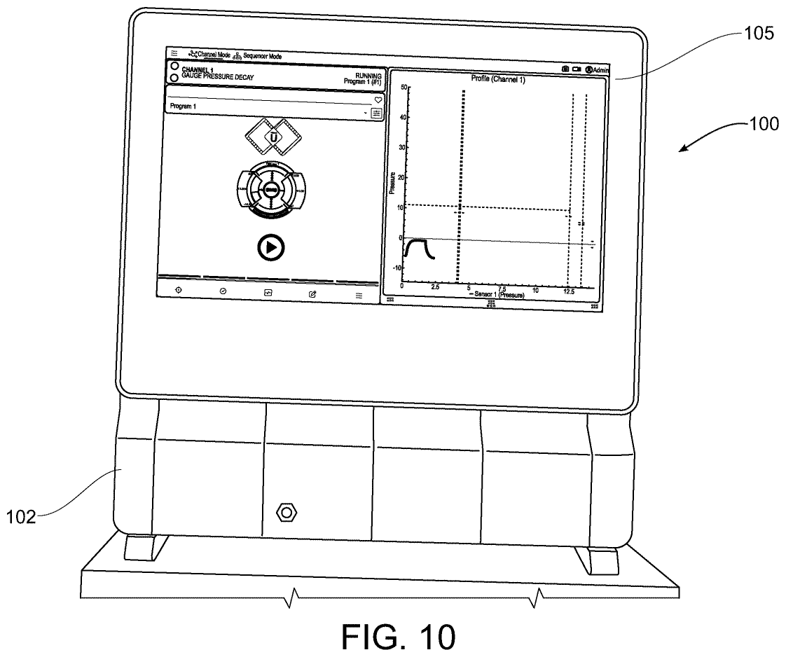

FIG. 10 illustrates a primary enclosure 102, which constitutes the static portion of the leak testing system 100 that is shipped to the customer. As shown, the enclosure 102 is configured to accommodate up to four channels, with a UI positioned on the front panel to facilitate leak testing system 100 operation. The multifunction gauge interface may be integrated within this user interface, as can be seen on the left side of the screen, providing real-time test cycle visualization, step tracking, and dynamic sensor feedback for improved leak test interpretation.

In the illustrated embodiment, the leak testing system 100 architecture includes several components. The front panel is equipped with a touchscreen display 105, which serves as the primary means of interaction between the user and the leak testing system 100. The touchscreen interface allows for test programming, leak testing system 100 control, and real-time visualization of test results. The multifunction gauge interface may be integrated within this touchscreen.

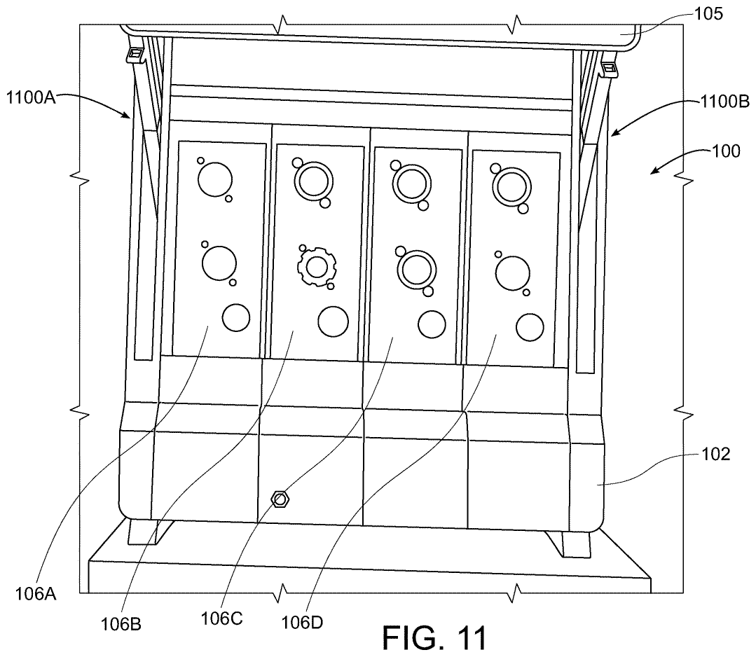

FIG. 11 depicts the leak testing system 100 access mechanism, which allows authorized personnel to open the enclosure 102 for maintenance or modifications. Access to the enclosure 102 is regulated through the user interface, with specific permissions required for entry, as described and illustrated in more detail below. The leak testing system 100 is equipped with one or more electronic latches 110A-B positioned on either side of the enclosure 102 to restrict unauthorized access. In some embodiments, a mechanical override mechanism (as described herein with reference to FIG. 7) is provided to permit access in the event of a power failure or other emergency conditions. The access control functionality ensures that only users with the appropriate authorization can disengage the electronic latches 1100A-B and open the enclosure 102. Upon gaining access, the modular channel boxes 106A-D become visible and accessible for adjustment of leak testing system components 100 (e.g., pneumatic components 108A-D) within the enclosure 102.

As shown, one example of this leak testing system 100 architecture supports up to four channel boxes 106A-D, which are designed to operate within a modular framework. Each channel box 106A-D is a discrete subassembly that may be configured with different functional components depending on specific testing requirements. The modular design allows for flexible positioning of channel boxes 106-D within the enclosure 102, with no restrictions on placement. Spare channel boxes may be maintained on-site to facilitate rapid replacement, thereby minimizing leak testing system 100 downtime. In some embodiments, if a channel box 106A-D requires calibration, modification, or replacement, the existing unit may be removed and a spare unit may be installed in its place. This configuration enhances leak testing system 100 uptime by allowing for quick substitution without requiring extensive service interruptions.

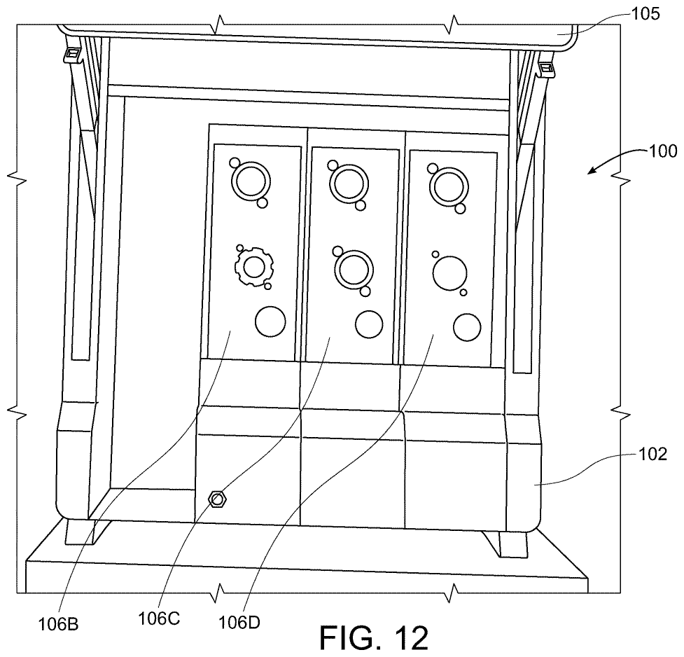

FIGS. 9B-9C illustrates the removal of a channel box 106C from the leak testing system 100 and FIG. 12 illustrates a leak testing system 100 with a channel box 106A removed. The removed channel box 106A may be sent for modifications, calibration, or servicing while a spare channel box is installed in its place. This modular approach ensures that the leak testing system 100 remains fully functional during the transition, thereby minimizing or nearly eliminating downtime.

The rear section of the enclosure 102 incorporates a backplane board, which functions as the conduit for electrical communication and power distribution. This backplane board establishes connectivity between the onboard computing unit (e.g., MCU 104) and the electronics within the channel boxes 106A-D, facilitating seamless communication and control. In some embodiments, this backplane board facilitates real-time data transmission between the test control system and the multifunction gauge interface, ensuring that test results, pressure trends, and valve state indicators remain continuously updated for operator review.

The main enclosure 102 also integrates pneumatic connections, which are positioned on the side of the leak testing system 100 for user access. These connections allow for the application of supply pressure to the leak testing system 100, ensuring reliable and repeatable pneumatic conditions for leak testing. In some embodiments, the multifunction gauge interface reflects real-time pressure levels, regulator adjustments, and valve actuation to provide immediate visual feedback on test conditions.

In some embodiments, the pneumatic connections support multiple pressure ranges, allowing the leak testing system 100 to accommodate a variety of testing requirements, including vacuum conditions and pressures up to and exceeding 1000 psi. The leak testing system 100 is designed to permit precise pressure application to each of the channel boxes 106A-D based on its configured pressure range. Additionally, the enclosure 102 includes a rear connection bay that houses various interfaces, including an Ethernet port for fieldbus communication, power connections, a power button, and digital I/O ports. These interfaces allow external control of the leak testing system 100 via a PLC or remote pendant. The power inlet is also positioned at the rear of the enclosure 102, ensuring an organized and centralized access point for leak testing system 100 power management.

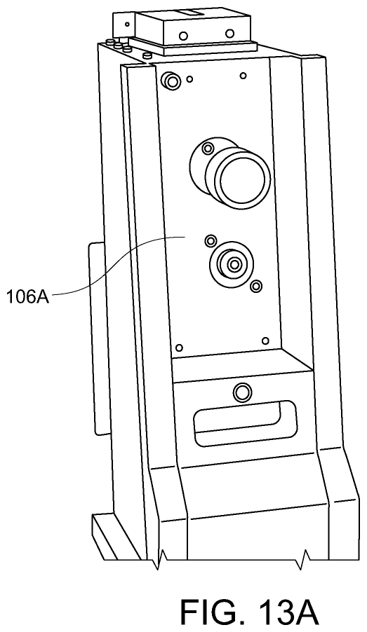

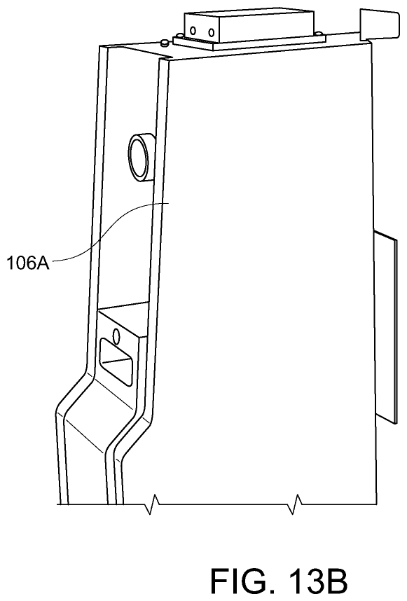

FIGS. 13A-B depict a single channel box 106A extracted from a four-bay enclosure 102 (e.g., as illustrated in FIG. 12), illustrating the structural configuration of the channel box 106A within the static portion of the leak testing system 100.

As illustrated in FIG. 14, the backplane board 1400 functions as the primary conduit for electrical communication and power distribution. This backplane board 1400 serves as the interface between the power inlet of the leak testing system 100 and the electronics within the channel boxes 106A-D, facilitating seamless data transmission between the channel boxes 106A-D and the single-board computer (SBC) of the leak testing system 100.

FIG. 12 depicts an enclosure with the screen raised, revealing four docked channel boxes. The pneumatic docking mechanism is located at the top of the assembly. The distribution manifold, which is positioned within the main enclosure, is configured to mate with a corresponding receiving manifold inside the channel box.

The pneumatic supply connections from the external system deliver compressed air to the distribution manifold, which is designed to allocate the supplied pressures to individual channel boxes 106A-D. The receiving manifold inside each of the channel boxes 106A-D is responsible for regulating the transmitted pressures, determining which pressure levels are directed into the internal pneumatic system of the respective channel. The configuration of the receiving manifold is dependent on the specific requirements of the channel boxes 106A-D, ensuring compatibility with various test applications. In some embodiments, the multifunction gauge interface dynamically updates pressure trends and regulator responses.

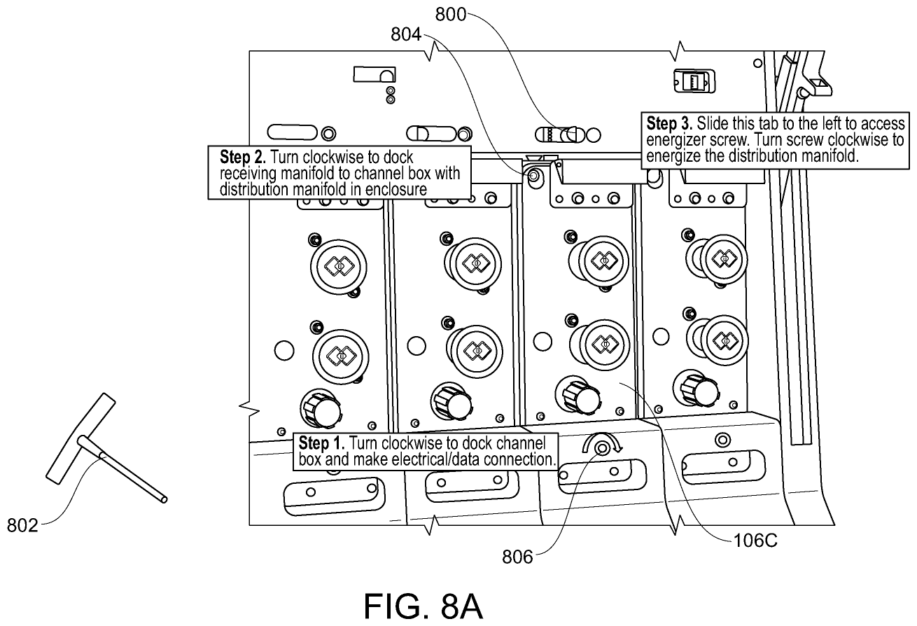

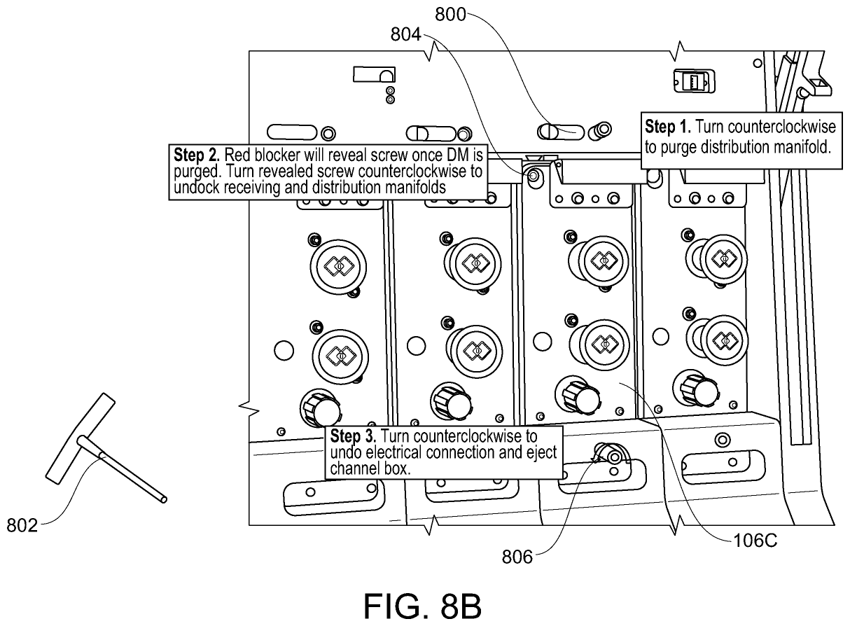

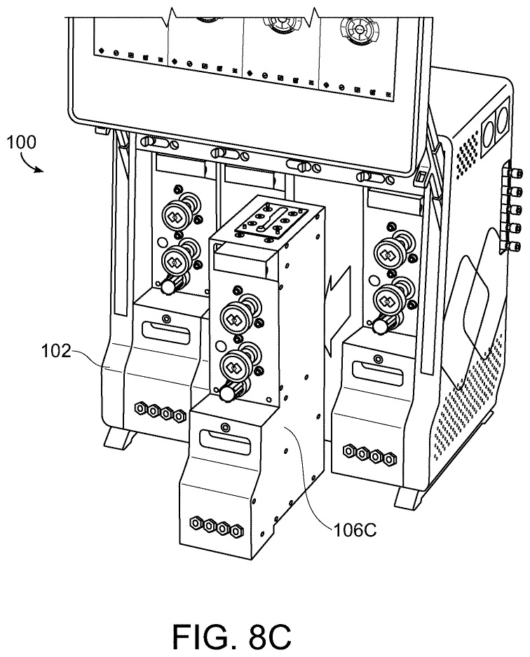

FIGS. 8A-C illustrate the sequence of operations required to undock and dock the channel box 106C detailed herein. The undocking process follows a predefined order to ensure system safety and prevent unintentional pressurization.

The docking and undocking processes are governed by a sequential mechanism that enforces a structured order of operations to ensure proper engagement. Initially, the electrical connections at the rear horizontal docking interface must be fully secured. Once these electrical connections are established, the application of pressure is restricted until the pneumatic docking process is completed. In some embodiments, once electrical docking takes place, while the channel box 106C may be powered and communicating with the leak testing system 100, the channel box 106C may not be able to run tests until the pneumatic docking process is completed. Upon the successful engagement of the pneumatic docking mechanism, the leak testing system 100 may then be energized.

During the undocking process, this order of operations is reversed to ensure a controlled disconnection sequence. The system must first be de-energized, followed by the disengagement of the pneumatic docking mechanism at the upper section of the channel box. Only after these steps have been executed can the horizontal docking mechanism at the rear be released, providing for the removal of the channel box from the system.

As depicted in FIG. 8B, the first step in the undocking sequence involves engaging lead screws 800 using a hex tool 802, thereby initiating the de-energization of the leak testing system 100 or purging of the distribution manifold. This step ensures that leak testing system 100 pressure is shut off and residual pressure is vented, placing the leak testing system 100 in a safe state. Once depressurization is complete, the pneumatic docking mechanism, which is oriented vertically, is disengaged. A red blocker will reveal lead screw 804 once the distribution manifold is purged, which is turned counterclockwise to undock receiving and distribution manifolds. Then, the lead screw 806 is engaged to undo the electrical connection. Subsequently, the horizontal docking mechanism at the rear of the channel box 106C is released, allowing the unit to be fully undocked.

Once the horizontal docking mechanism is disengaged, the channel box 106C can be removed from the enclosure 102, as illustrated in FIG. 8C. The removal of the channel box 106C may be performed for various purposes, including maintenance, calibration, modification, or component upgrades. The modular architecture of the leak testing system 100 permits a rapid substitution of a replacement unit, minimizing downtime and ensuring operational continuity.

As depicted in FIG. 8A, the first step in the docking sequence involves engaging lead screw 8060 make the electrical and data connections. In a second step, the lead screw 804 is engaged to dock the receiving manifold to the channel box 106C with the distribution manifold in the enclosure 102. In a third step, a tab is slid to the side to reveal energizer or lead screw 800, which is engaged to energize the distribution manifold.

FIG. 15 provides a side view of the leak testing system 100, illustrating the internal components of a channel box 106. As described previously, the pneumatic distribution manifold 1500 supplies pressurized air to the receiving manifold 1502 located within the channel box. The receiving manifold 1402 is responsible for directing the appropriate pressures into the pneumatic components 108 of the channel box 106.

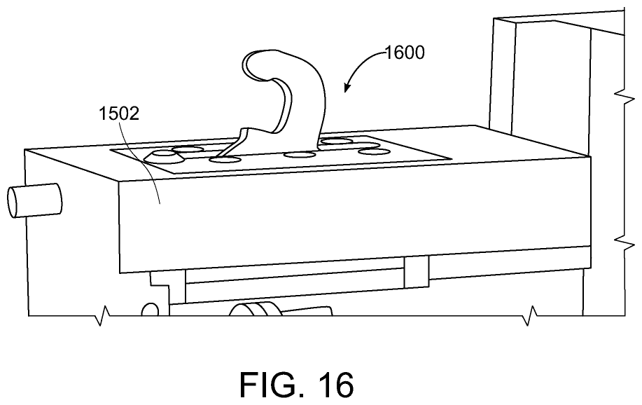

FIG. 16 further illustrates the engagement mechanism between the distribution manifold 1400 and the receiving manifold 1402. A draw latch 1600 is employed to elevate the receiving manifold 1402, ensuring a secure face seal between the two components. The receiving manifold 1402 determines which pressure levels are transmitted into the leak testing system 100, thereby ensuring precise pressure regulation, with adjustments reflected in real-time on the multifunction gauge interface to ensure operators can monitor system stability and test conditions at a glance. The pneumatic docking system, inclusive of the pneumatic connection manifold facilitates interchangeable deployment and rapid servicing.

The channel box 106 may further include several components, including the electrical connection system, which facilitates docking at the rear of the enclosure 102. The TCC 108, which serves as the dedicated circuit board for the channel box 106, is housed within this the channel box 106. The TCC 108 is responsible for storing configuration-specific data, processing sensor analog signals, executing test operations, and controlling the operation of valves. The TCC 108 ensures the precise execution of test sequences. The multifunction gauge interface continuously receives data from the TCCs 108A-D, ensuring that live test conditions are displayed dynamically for operator interpretation.

Additionally, the channel box 106 contains downstream pneumatic components 108, including independent, dedicated pressure regulators. The pneumatic components 108 are structured to accommodate various operating pressures. For example, if the leak testing system 100 receives an overall pneumatic supply pressure of 165 psi, but a specific one of the channel boxes 106A-D is configured to operate at 60 psi, the integrated regulator within the one of the channel boxes 106A-D adjusts the pressure accordingly. The channel box 106 also incorporates all channel-specific sensors, valves, and other pneumatic elements necessary for executing the respective test. These pressure adjustments and real-time sensor feedback are visually represented on the multifunction gauge interface, allowing operators to verify stability and compliance with test parameters at a glance. The channel boxes 106A-D also incorporate all channel-specific sensors, valves, and pneumatic elements necessary for executing each test cycle, ensuring that each test step is dynamically updated on the multifunction gauge interface for improved visibility and intuitive test interpretation.

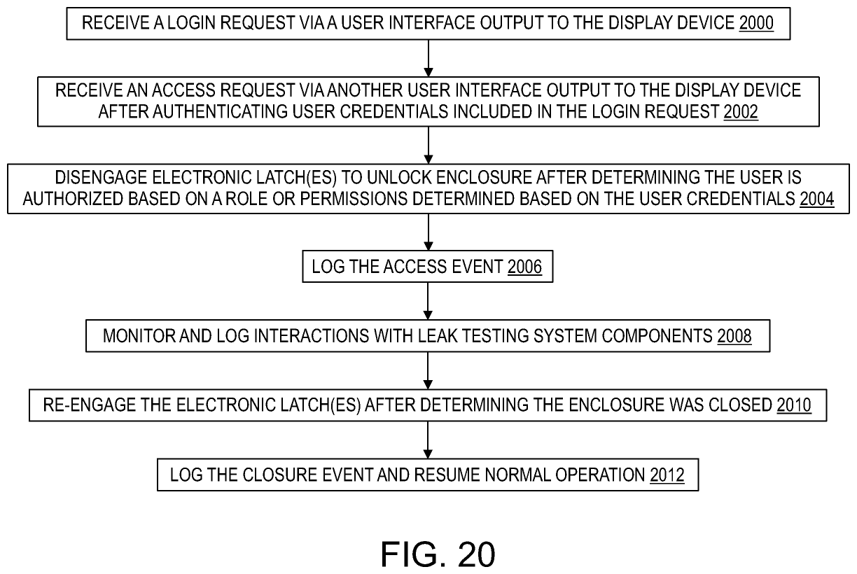

The data analytics functionality of the exemplary leak testing system 100 disclosed herein may be designed to support pneumatic channel independence and expanded graphing capabilities, allowing for advanced data visualization and interpretation. The exemplary user interfaces of the leak testing system 100, as depicted in FIGS. 3, 5A, 9A-C and FIGS. 20-43, for example, provide an enhanced user experience, featuring a flexible home page with configurable widgets and a large multi-touch display 105. The setup process is streamlined to improve efficiency, while plot functionality is enhanced to facilitate test data review and analysis. The leak testing system 100 architecture supports independent channels, as explained in detail above, thereby increasing operational flexibility.

In some embodiments, the leak testing system 100 includes a relatively large touchscreen display 105 to provide an optimized user interface. The architecture ensures improved support for independent channel operations. The home screen configuration is flexible, allowing for customization based on user preferences. The program setup process is simplified and streamlined to enhance overall usability. Thus, the disclosed leak testing system 100 includes a modular and customizable user interface that is designed to facilitate user interaction while adapting to the specific needs of the logged-in user, their role, and the leak testing system 100 state. This modular user interface enhances usability by ensuring that only the most relevant controls, indicators, and data outputs are displayed at any given time.

The exemplary user interfaces of the leak testing system 100, which are described and illustrated in detail below with reference to FIGS. 20-31, are structured into dedicated sections (also referred to as panes or apertures), with each section corresponding to an individual functional leak testing system 100 channel (each corresponding to one of the channel boxes 106A-D). These sections provide configurable and resizable functional elements that adjust dynamically based on the active testing channel, the leak testing system 100 state, and/or the user's permissions. The modular design of the user interface allows specific functional elements to be included, excluded, resized, or repositioned as required.

The leak testing system 100 in some examples supports role-based user interface customization, which ensures that the user interface presents appropriate controls and indicators according to the access privileges of the user. For example, an admin has full leak testing system 100 access and is capable of modifying all configurations, accessing service functions, and overriding test parameters. A supervisor may be able to review results, adjust non-critical settings, and manage test programs. Operators may be restricted to executing predefined test sequences and monitoring test progress. System administrators can be responsible for IT-related management, such as network settings and data export configurations. Service technicians can have limited access to diagnostic and maintenance tools. The user's role can be managed based on a login procedure and stored roles associated with login credentials, for example.

The modular user interface may offer a range of functional elements, which can be assigned to different sections based on user needs and specific leak testing system 100 configurations. These functional elements include a start/abort button that provides direct control over initiating and terminating tests, a multi-functional gauge that displays real-time sensor readings such as pressure, flow, or leak rate, and an accept/reject indicator that signals test pass or fail status based on programmed criteria. Additionally, the user interface provides a digital I/O status to display the active states of external digital input and output signals, a holding register display for showing real-time numerical data used in ongoing test procedures, and a progress bar to visually indicate the completion status of the test cycle.

Further functional elements may include a process curve display that graphically represents live and historical test data, such as pressure decay, flow rate trends, and response curves. A tabulated step results section displays detailed test step outcomes in tabular form for review and analysis. Additionally, a program selection interface allows users to choose and load predefined test programs.

The configurability of these elements enables users to create a personalized testing interface tailored to their workflow. For instance, an operator might only see essential start and abort buttons as well as pass and fail indicators, while a supervisor would have access to program selection options and detailed step result data. Similarly, a service technician could view additional diagnostic data, such as valve activation states and system health indicators, which are necessary for maintenance tasks.

The modular user interface may be optimized to adjust dynamically based on the current leak testing system 100 state. For example, during leak testing system 100 calibration, the user interface may emphasize gauge readings and process curves, whereas in production mode, it prioritizes start controls, status indicators, and pass/fail outputs. In error conditions, the user interface highlights diagnostic tools and troubleshooting recommendations to assist users in resolving issues efficiently. This adaptive and modular user interface architecture advantageously enhances operational efficiency, reduces human error, and ensures that each user interacts with the leak testing system 100 in a manner that is best suited to their role and the current test conditions.

In some examples, the leak testing system 100 includes the channel boxes 106A-D each comprising a TCC 110A-D and pneumatic components 108A-D, wherein each of the TCCs 110A-D is configured to perform a different test procedure using the pneumatic components. In the examples, the enclosure 102 is coupled to a display device 106 and houses memory having instructions stored thereon and also houses the MCU 104. The enclosure 102 is configured to separately receive each of the channel boxes 106A-D and thereby pneumatically couple the channel boxes 106A-D to the enclosure 102. The MCU 104 is coupled to the memory, communicably coupled to the TCCs 110A-D when the channel boxes 106A-D are received by the enclosure, and configured to execute the stored instructions to generate, provide to the display 105 (also referred to herein as a display device), and otherwise facilitate the functionality of the user interfaces described and illustrated by way of the examples herein.

The memory can be coupled to the MCU 104 via a PCB and/or be part of the TCCs 110A-D and/or the backplane PCB 1400. The memory can be one or more non-transitory computer readable media having stored thereon instructions comprising executable code that, when executed by one or more processors (e.g., processors of the MCU 104 and/or PCBs hosting the TCCs 110A-D), causes the one or more processors to generate, provide to the display 105, and otherwise facilitate the functionality of the user interfaces described and illustrated by way of the examples herein.

Disclosed herein in some examples (e.g., as explained above with reference to FIGS. 7 and 11) is a physical access control system integrated within the exemplary modular leak testing system 100. This leak testing system 100 utilizes permission-based electronic latching mechanisms (e.g., electronic latches 1100A-B) to regulate access to adjustable or serviceable components (e.g., pneumatic components 108A-D or other components of the channel boxes 106A-D) within the enclosure 102. Access control is implemented through a combination of software and hardware elements, including user authentication via a graphical user interface (UI), actuators of the electronic latches 1100A-B, and integrated access logging mechanisms.

The leak testing system 100 in these examples includes a primary enclosure 102 that houses the test components, including channel boxes 106A-D, pneumatic components 108A-D, and electronic control modules (e.g., TCCs 110A-D). In some embodiments, to ensure compliance with regulatory requirements such as FDA and ISO13485 standards, all access to internal components may be logged in an audit system that tracks user identity, time of access, and the specific modifications performed, for example, although other information can also be logged in other examples.

In some examples, access control begins with an authentication process conducted via the leak testing system 100 UI, which is presented on a touchscreen interface display 105 mounted on the front panel of the enclosure 102 via electronic latches 1100A-B that act as a hinge for the display 105 relative to the enclosure 102 and include actuators configured to selectively engage and disengage the electronic latches 1100A-B based on instructions or signals generated by the MCU 104. Users attempting to access the internal components (e.g., the channel boxes 106A-D) can first log in using unique user credentials, which may include a username-password combination, a biometric scan, or an RFID-based authentication token, for example, although other types of secure login and/or authentication procedures can also be used in other examples.

Upon authentication, users may submit an access request via the UI. The access request is processed by the MCU 104, which verifies the user's permission level and/or role (that can correspond with a permission level). If the user possesses the appropriate permissions and the leak testing system 100 is in a safe operational state, the request is approved by the MCU. The electronic latches 1100A-B are then actuated to unlock the enclosure 102, granting physical access to the internal components (e.g., the channel boxes 106A-D). If the user lacks the necessary permissions, or if the leak testing system 100 is engaged in an active test operation, the request may be denied, and a corresponding entry may be logged in the audit system (e.g., in a database or other data structure in the memory coupled to the MCU 104).

In some examples, the enclosure 102 is equipped with electronic latches 1100A-B that physically restrict access to adjustable and serviceable components (e.g., channel boxes 106A-D). These electronic latches 1100A-B that are controlled via a microcontroller (e.g., the MCU 104 or a processor associated therewith or communicably coupled thereto) and are only released upon successful authentication and authorization. In some examples, to ensure compliance with security protocols, the leak testing system 100 employs a fail-secure mechanism wherein the electronic latches 1100A-B that remain locked in the event of a power failure, preventing unauthorized access.

In the case of emergency maintenance, a secondary mechanical screen latch override 202 may be provided in some examples. In these examples, this screen latch override 202 is physically secured and can only be accessed using a dedicated physical key held by authorized personnel. When the screen latch override 202 is used, the override event is logged based on an electronic message or signal communicated to the MCU, ensuring traceability of access under all conditions.

In some examples, to maintain traceability, all access attempts—whether successful or denied—are recorded in a secure audit log (e.g., in the memory coupled to the MCU 104). This log includes details such as user identification, time of access request, approval or denial status, and a summary of any actions taken within the enclosure 102 during the access period. In some examples, this audit data is stored in a non-volatile memory location and can be retrieved for compliance audits or leak testing system 100 diagnostics.

In some examples, the leak testing system 100 may be integrated with a remote monitoring server that allows security administrators or compliance officers to remotely access audit logs stored on the leak testing system 100. Additionally, configurable alerts may be enabled to notify designated personnel when unauthorized access attempts occur or any other triggers are identified.

In some examples, the leak testing system 100 can implement multiple safety interlocks to ensure operational security when the enclosure 102 is open. Sensor(s) embedded within the electronic latches 1100A-B can be used to detect whether the enclosure 102 is open or closed. If the leak testing system 100 is engaged in an active test process, access to the enclosure 102 may be automatically restricted, preventing accidental modification of critical settings. In the event that the enclosure 102 is opened while the leak testing system 100 is idle, operational restrictions can be enforced to prevent test execution until the enclosure 102 is securely closed and re-locked.

Additionally, the leak testing system 100 can be configured to support different access levels. For instance, a service technician may have permission to access and replace certain hardware components, while an operator may only have the ability to inspect or perform routine maintenance. In some examples, these access levels can be customized through user management settings, ensuring that permissions align with organizational security protocols.

Referring now to FIG. 20, a flowchart of an exemplary method for securing physical access control to the leak testing system 100 via user permission levels is illustrated. In step 2000 in this example, the leak testing system 100 (e.g., the MCU 104) receives a login request via a user interface output to the display 105. In step 2002, after authenticating the user credentials included in the login request (e.g., based on contents of a local or remote access management database or other data structure), the leak testing system 100 receives an access request via another user interface output to the display 105. Thus, users can engage with user interfaces generated and provided to the display 105 by the MCU 104 in accordance with their access level, role, or permissions to perform any number of tasks as well as request access to leak testing system 100 components within the enclosure 102.

If the leak testing system 100 determines that an access request has been received, then the leak testing system 100 determines in step 2004 whether the user is authorized to access components of the leak testing system 100 within the enclosure based on the user's credentials and associated access level, role, or permissions, which can be stored in the access management database, for example. If the leak testing system 100 determines that the access request should be denied because the user is not authorized (or because a leak test is currently in progress), then the method ends and the user is denied access to components with the enclosure 102.

However, if the leak testing system 100 determines that the access request should be granted, then the leak testing system 100 proceeds to disengage the electronic latches 1100A-B to unlock the enclosure 102. The electronic latches 1100A-B can include actuators communicably coupled to and controllable by the MCU 104 to facilitate the disengagement (and subsequent engagement). By disengaging the electronic latches 1100A-B, the display 105 is allowed to rotate about hinge(s) coupled to the enclosure 102 to thereby reveal the channel boxes 106A-D and other associated internal components of the leak testing system 100.

In step 2006, the leak testing system 100 logs the access event by storing audit data in the local memory or remotely via a communicably coupled server, for example. The audit data can include the user's identity and a time stamp corresponding to the access event, for example, although other audit data can also be maintained in other examples. Optionally, if the user is denied access in step 2004, the access denial event (e.g., user credentials and a reason for the denial) can also be logged via stored audit data.

In step 2008, the leak testing system 100 monitors user interactions with leak testing system 100 components (e.g., pneumatic components 108A-D or other components associated with the channel boxes 106A-D. In this step, the leak testing system 100 can also log a summary of the actions or interactions with the components within the enclosure 102 by storing interaction data, such as a time an action was taken, the component associated with the action, and parameter(s) or other aspect(s) of the component that were adjusted.

In step 2010, the leak testing system 100 re-engages the electronic latches 1100A-B after determining the enclosure 102 was closed by a user. For example, sensors coupled to the electronic latches 1100A-B can be configured to communicate with the MCU 104 an indication that the electronic latches 1100A-B were manually closed. In response, the MCU 104 can re-engage actuators coupled to the electronic latches 1100A-B to ensure secure closure of the enclosure 102 via the display 105 preventing access to the channel boxes 106A-D. In other examples, the electronic latches can be configured to automatically engage based on a manual (or UI-controlled) closure of the display 105 via the hinges coupled to the enclosure 102.

In step 2012, the leak testing system 100 logs the closure event and resumes normal operations. The closure event can be logged by storing audit data, such as the user's identity/username credential and a timestamp in an audit database or other data structure locally (e.g., in the memory coupled to the MCU) or remotely. Other information can also be logged regarding the closure event or any other activity or interaction with the leak testing system 100 in other examples.

Thus, in some disclosed examples of this technology, the enclosure 102 includes an electronic latching mechanism (e.g., electronic latches 1100A-B and associated sensors and/or actuators) that secures the touchscreen panel display 105 to prevent unauthorized access to the internal components of the leak testing system. The electronic latches 1100A-B are actuated based on user authentication inputs received via the leak testing system 100 GUI. The electronic latches 1100A-B may integrate with a microcontroller (e.g., of the MCU 104 or backplane PCB 1400) to ensure secure actuation and continuous monitoring of the state of the electronic latches 1100A-B.

In some examples, the access control system includes a secondary mechanical screen latch override 202. This screen latch override 202 includes a physical key system embedded near the electronic latches 1100A-B. The key provides access to authorized personnel only. In some examples, all instances of mechanical access are also logged in the audit data. Upon engaging the physical key, the touchscreen panel display 105 is released via the electronic latches 1100A-B, thereby granting user access to components within the enclosure 102.

While various illustrative embodiments incorporating the principles of the present teachings have been disclosed, the present teachings are not limited to the disclosed embodiments. Instead, this application is intended to cover any variations, uses, or adaptations of the present teachings and use its general principles. Further, this application is intended to cover such departures from the present disclosure that are within known or customary practice in the art to which these teachings pertain.

In the above detailed description, reference is made to the accompanying drawings, which form a part hereof. In the drawings, similar symbols typically identify similar components, unless context dictates otherwise. The illustrative embodiments described in the present disclosure are not meant to be limiting. Other embodiments may be used, and other changes may be made, without departing from the spirit or scope of the subject matter presented herein. It will be readily understood that various features of the present disclosure, as generally described herein, and illustrated in the Figures, can be arranged, substituted, combined, separated, and designed in a wide variety of different configurations, all of which are explicitly contemplated herein.

The present disclosure is not to be limited in terms of the particular embodiments described in this application, which are intended as illustrations of various features. Many modifications and variations can be made without departing from its spirit and scope, as will be apparent to those skilled in the art. Functionally equivalent methods and apparatuses within the scope of the disclosure, in addition to those enumerated herein, will be apparent to those skilled in the art from the foregoing descriptions. It is to be understood that this disclosure is not limited to particular methods, reagents, compounds, compositions or biological systems, which can, of course, vary. It is also to be understood that the terminology used herein is for the purpose of describing particular embodiments only and is not intended to be limiting.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” et cetera). While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

As used in this document, the singular forms “a,” “an,” and “the” include plural references unless the context clearly dictates otherwise. Unless defined otherwise, all technical and scientific terms used herein have the same meaning as commonly understood by one of ordinary skill in the art. Nothing in this disclosure is to be construed as an admission that the embodiments described in this disclosure are not entitled to antedate such disclosure by virtue of prior invention.

In addition, even if a specific number is explicitly recited, those skilled in the art will recognize that such recitation should be interpreted to mean at least the recited number (for example, the bare recitation of “two recitations,” without other modifiers, means at least two recitations, or two or more recitations). Furthermore, in those instances where a convention analogous to “at least one of A, B, and C, et cetera” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, et cetera). In those instances where a convention analogous to “at least one of A, B, or C, et cetera” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, et cetera). It will be further understood by those within the art that virtually any disjunctive word and/or phrase presenting two or more alternative terms, whether in the description, sample embodiments, or drawings, should be understood to contemplate the possibilities of including one of the terms, either of the terms, or both terms. For example, the phrase “A or B” will be understood to include the possibilities of “A” or “B” or “A and B.”

In addition, where features of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, et cetera. As a non-limiting example, each range discussed herein can be readily broken down into a lower third, middle third and upper third, et cetera. As will also be understood by one skilled in the art all language such as “up to,” “at least,” and the like include the number recited and refer to ranges that can be subsequently broken down into subranges as discussed above. Finally, as will be understood by one skilled in the art, a range includes each individual member. Thus, for example, a group having 1-3 components refers to groups having 1, 2, or 3 components. Similarly, a group having 1-5 components refers to groups having 1, 2, 3, 4, or 5 components, and so forth.

Various of the above-disclosed and other features and functions, or alternatives thereof, may be combined into many other different systems or applications. Various presently unforeseen or unanticipated alternatives, modifications, variations or improvements therein may be subsequently made by those skilled in the art, each of which is also intended to be encompassed by the disclosed embodiments.

Having thus described the basic concept of the invention, it will be rather apparent to those skilled in the art that the foregoing detailed disclosure is intended to be presented by way of example only and is not limiting. Various alterations, improvements, and modifications will occur and are intended to those skilled in the art, though not expressly stated herein. These alterations, improvements, and modifications are intended to be suggested hereby, and are within the spirit and scope of the invention. Additionally, the recited order of processing elements or sequences, or the use of numbers, letters, or other designations, therefore, is not intended to limit the claimed processes to any order except as may be specified in the claims. Accordingly, the invention is limited only by the following claims and equivalents thereto.

What is claimed is:

1. A leak testing system, comprising:
at least one channel box; and
an enclosure configured to receive the channel box, coupled to a display device via one or more electronic latches, and housing memory having instructions stored thereon and a main control unit (MCU) coupled to the memory and the electronic latches and configured to execute the stored instructions to:
determine that a user is authorized to access the channel box in response to an access request received from the user after authenticating credentials for the user received with a login request via a user interface output to the display device;
control the electronic latches to disengage to thereby unlock the display device and permit movement of the display device away from the enclosure, wherein user access to the channel box is permitted when the display device is unlocked;
determine that the enclosure was closed; and
control the electronic latches to re-engage to thereby lock the display device and restrict movement of the display device relative to the enclosure, wherein user access to the channel box is prevented when the display device is locked.

2. The leak testing system of claim 1, wherein the channel box comprises a plurality of components and the MCU is further configured to execute the stored instructions to:
monitor one or more interactions with one or more of the components; and
log audit data associated with the interactions.

3. The leak testing system of claim 2, wherein the audit data comprises one or more of a time the interactions occurred, the one or more of the components associated with the interactions, or one or more parameters of the one or more of the components that were adjusted as part of the interactions.

4. The leak testing system of claim 2, wherein the channel box comprises one or more sensors, one or more test ports, one or more pressure regulators, or valving and the components comprise at least one main regulator, at least one auxiliary manual regulator, and an internal vacuum generation circuit.

5. The leak testing system of claim 2, wherein the channel box comprises a test channel controller (TCC), the MCU is communicably coupled to the TCC when the channel box is received by the enclosure, and the MCU is further configured to execute the stored instructions to monitor the interactions with the components based on one or more communications with the TCC.

6. The leak testing system of claim 5, wherein the TCC comprises a TCC printed circuit board (PCB) comprising a first set of one or more processors, the MCU comprises a second set of one or more processors, and the enclosure further comprises a backplane printed circuit board (PCB) configured to connect the MCU to the TCC PCB via a backplane interface connector of the TCC PCB.

7. The leak testing system of claim 1, wherein the MCU is further configured to execute the stored instructions to determine that the enclosure was closed based on position data received from one or more sensors coupled to the enclosure proximate the electronic latches, wherein the position data indicates proximity of the display device relative to the enclosure.

8. The leak testing system of claim 1, wherein the MCU is further configured to execute the stored instructions to log audit data associated with one or more of the access request or the closure of the enclosure, wherein the audit data comprises at least an identity of the user and a timestamp of the access request or the closure of the enclosure.

9. The leak testing system of claim 8, wherein the MCU is further configured to execute the stored instructions to provide via one or more communications networks at least a portion of the audit data in response to a request received from a remote monitoring server coupled to the leak testing system via the communications networks.

10. The leak testing system of claim 1, wherein the MCU is further configured to execute the stored instructions to determine that the user is unauthorized to access the channel box in response to the access request when a test procedure is currently executing on the leak testing system.

11. The leak testing system of claim 1, further comprising a control panel coupled to the MCU and the electronic latches and housing latch control circuitry, wherein the MCU is configured to control the electronic latches to disengage and re-engage via communication with the latch control circuitry.

12. The leak testing system of claim 1, wherein the MCU is further configured to execute the stored instructions to generate and output an alert upon determining that the user is unauthorized to access the channel box.

13. The leak testing system of claim 1, wherein the electronic latches are configured to remain engaged during a power failure such that user access to the channel box is prevented.

14. The leak testing system of claim 1, wherein the enclosure is further coupled to the display device via a screen latch override comprising a mechanical latch operable via a key and the MCU is further configured to execute the stored instructions to log audit data associated with a mechanical access upon determining that the enclosure was mechanically accessed via the screen latch override.

15. The leak testing system of claim 1, further comprising a plurality of other channel boxes, wherein each of the channel box and the other channel boxes is separately removable from the enclosure.

16. A non-transitory computer readable medium having stored thereon instructions comprising executable code that, when executed by one or more processors of a main control unit (MCU) of a leak testing system, causes the one or more processors to:
determine that a user is authorized to access a channel box in response to an access request received from the user after authenticating credentials for the user received with a login request via a user interface output to a display device coupled to an enclosure of the leak testing system via one or more electronic latches, wherein the enclosure is configured to receive the channel box and the MCU is coupled to the electronic latches;
control the electronic latches to disengage to thereby unlock the display device and permit movement of the display device away from the enclosure, wherein user access to the channel box is permitted when the display device is unlocked;
determine that the enclosure was closed; and
control the electronic latches to re-engage to thereby lock the display device and restrict movement of the display device relative to the enclosure, wherein user access to the channel box is prevented when the display device is locked.

17. The non-transitory computer readable medium of claim 16, wherein the channel box comprises a plurality of components and the executable code, when executed by the processors, further causes the processors to:
monitor one or more interactions with one or more of the components; and
log audit data associated with the interactions.

18. The non-transitory computer readable medium of claim 16, wherein the executable code, when executed by the processors, further causes the processors to log audit data associated with one or more of the access request or the closure of the enclosure, wherein the audit data comprises at least an identity of the user and a timestamp of the access request or the closure of the enclosure.

19. The non-transitory computer readable medium of claim 16, wherein the enclosure is further coupled to the display device via a screen latch override comprising a mechanical latch operable via a key and the executable code, when executed by the processors, further causes the processors to log audit data associated with a mechanical access upon determining that the enclosure was mechanically accessed via the screen latch override.

20. A method implemented by a main control unit (MCU) of a leak testing system, the method comprising:
determining that a user is authorized to access a channel box in response to an access request received from the user after authenticating credentials for the user received with a login request via a user interface output to a display device coupled to an enclosure of the leak testing system via one or more electronic latches, wherein the enclosure is configured to receive the channel box and the MCU is coupled to the electronic latches;
controlling the electronic latches to disengage to thereby unlock the display device and permit movement of the display device away from the enclosure, wherein user access to the channel box is permitted when the display device is unlocked;
determining that the enclosure was closed; and
controlling the electronic latches to re-engage to thereby lock the display device and restrict movement of the display device relative to the enclosure, wherein user access to the channel box is prevented when the display device is locked.
